(19) United States
(12) Patent Application Publication
(10) Pub. No.: US 2026/0236795 A1
(43) Pub. Date: Aug. 13, 2026

(54) ARTIFICIAL INTELLIGENCE-BASED, GRAPH-DRIVEN SYNTHETIC DATA GENERATION WITH STATISTICAL DISTRIBUTION AND TEMPORAL PATTERN PRESERVATION

(71) Applicant: Citibank, N.A., New York, NY (US)

(72) Inventors: Ganesh Prasad BHAT, New Jersey, NJ (US); James MYERS, Clearwater, FL (US); John E. ORTEGA, New York, NY (US)

(21) Appl. No.: 19/334,772

(22) Filed: Sep. 19, 2025

Related U.S. Application Data
(63) Continuation-in-part of application No. 19/050,102, filed on Feb. 10, 2025.

(51) Int. Cl. G06N 5/022

(52) U.S. Cl. CPC G06N 5/022

(57) ABSTRACT

Systems and methods for generating simulated datasets based on inferred statistical relationships, structural relationships, and semantic relationships using knowledge networks are disclosed herein. The system can receive a node dataset that includes entities and associated relationships. The system can generate an inferred statistical dataset characterizing statistical metric information associated with the entities and the relationships, thereby enabling generation of an inferred entity-relationship network including latent and explicit relationships and statistical correlations. Based on the inferred entity-relationship network and associated constraints, the system can generate simulated data that is consistent with the statistical, structural, and semantic relationships of the received node dataset, while protecting the underlying data on which the synthetic data is based. By doing so, the system enables training and validation of models associated with complex, distributed systems, while preventing exposure of sensitive or proprietary data.

### CROSS-REFERENCE TO RELATED APPLICATIONS

This application is a continuation-in-part of U.S. patent application Ser. No. 19/050,102 entitled “APPLICATION DOMAIN-BASED GENERATION AND CALIBRATION OF SYNTHETIC DATASETS USING ARTIFICIAL INTELLIGENCE MODELS” and filed Feb. 10, 2025. The content of the foregoing application is incorporated herein by reference in its entirety.

### BACKGROUND

Synthetic data refers to artificially generated information that mirrors the statistical properties, patterns, and characteristics of real-world data. Organizations across various industries increasingly rely on synthetic data for testing, development, and analysis purposes, particularly when working with sensitive information such as personal information, financial records, or healthcare data. The generation and use of synthetic data enables organizations to perform data analysis, testing, and development activities while maintaining compliance with privacy regulations and data protection requirements. Synthetic data provides a viable alternative that allows organizations to conduct necessary operations without compromising individual privacy or violating data protection regulations. However, generating synthetic data that maintains both the characteristics of the actual dataset and a verifiable degree of anonymization presents significant technical challenges, particularly in ensuring that the synthetic data accurately reflects real-world conditions while preventing reverse engineering to identify the original data sources.

### BRIEF DESCRIPTION OF THE DRAWINGS

FIG. 1 illustrates an example environment of a synthetic data generation platform for generating synthetic data.

FIG. 2 illustrates an example environment of a calibration engine of the synthetic data generation platform of FIG. 1 for generating a measurable tracking relationship value of the generated synthetic data.

FIG. 3 is a flow diagram illustrating an example process of generating calibrated synthetic data using the synthetic data generation platform of FIG. 1.

FIG. 4 illustrates a layered architecture of an artificial intelligence (AI) model system that can implement the machine learning models of the synthetic data generation platform of FIG. 1.

FIG. 5 is a block diagram showing some of the components typically incorporated in at least some of the computer systems and other devices on which the synthetic data generation platform of FIG. 1 operates.

FIG. 6 illustrates an example environment of a data simulation platform that enables generation of synthetic data based on an inferred entity-relationship network capturing structural, statistical, and semantic attributes, in accordance with one or more implementations of the disclosed technology.

FIG. 7A illustrates an example of a data simulation platform architecture that employs bidirectional integration between statistical inference and knowledge network generation, in accordance with one or more implementations of the disclosed technology.

FIG. 7B illustrates an example of a system architecture for generating simulated data based on real-world data, in accordance with one or more implementations of the disclosed technology.

FIG. 8A illustrates a knowledge network showing entity nodes and associated explicit relationships, in accordance with one or more implementations of the disclosed technology.

FIG. 8B illustrates an inferred entity-relationship network including modifications to the knowledge network of FIG. 8A, in accordance with one or more implementations of the disclosed technology.

FIG. 9 illustrates an example flowchart for a process for graph-driven synthetic data generation based on statistical inference of interdependencies and constraints, in accordance with one or more implementations of the disclosed technology.

FIG. 10A illustrates an example architecture for an anomaly preservation framework associated with the data simulation platform, in accordance with one or more implementations of the disclosed technology.

FIG. 10B illustrates an example of a privacy preservation framework associated with the data simulation platform, in accordance with one or more implementations of the disclosed technology.

### DETAILED DESCRIPTION

Synthetic data can be deployed to validate mathematical models and to train machine learning models such as large language models (LLMs) or other generative AI (GenAI, GAI) models. Synthetic data is used in a variety of fields as a filter for information that would otherwise compromise the confidentiality of particular aspects of the data. In many sensitive applications, datasets theoretically exist but cannot be released to the general public. Further, synthetic data addresses the challenge of data scarcity, which is common when implementing modern approaches to training LLMs or other generative AI models. Data scarcity occurs when there is an insufficient amount of real-world data available for analysis, training AI models, and other operations.

However, continuously using inaccurate synthetic data to, for example, train artificial intelligence (AI) models, increases the risk of model degradation. Inaccurate synthetic data includes data that, for example, has been generated/developed with incorrect assumptions, lacks variability, or contains errors and biases that are absent from original data (e.g., actual data, copies of the actual data, anonymized data, depersonalized data, and so forth). If an AI model continuously intakes inaccurate synthetic data, the AI model's performance and accuracy can degrade due to the over-reliance on artificial data that may not capture the nuances of real-world data. Over-reliance can lead to biased or inaccurate predictions and decisions. Another challenge is obtaining cross-border approval for the use of actual data. Different countries have varying regulations and standards for data privacy and protection, and synthetic data must comply with different regulations to be used legally. Navigating the regulatory landscapes can be complex and time-consuming, potentially delaying the deployment of AI models.

Attempting to create synthetic data that accurately reflects real-world conditions while ensuring compliance with privacy regulations presents significant technical challenges. Creating such data requires addressing several limitations in conventional approaches to data generation, such as the difficulty in maintaining the statistical properties of the original data while ensuring anonymization. Unlike traditional data anonymization methods that may simply remove or mask personal identifiers, synthetic data generation creates entirely new data points that mimic the original data's characteristics and cannot be reengineered to trace back to, for example, customers or other personally identifiable information (PII) or personal information (PI). Conventional methods often struggle to balance the need for data utility with the requirement for privacy, leading to either overly generalized data that lacks detail or insufficiently anonymized data that poses privacy risks.

To address these technical challenges, multiple design approaches were evaluated. For example, evaluations and analysis included generating synthetic data to reflect the statistical properties and patterns of the original data. However, a significant challenge remained: there was no measure of how good the synthetic data was, nor was there a method to track the differences between the original and synthetic data. Without a reliable measure of the quality of synthetic data, it was challenging to ensure that the generated data captured the nuances of the original data.

As such, the inventors have developed a system for generating calibrated synthetic data using an AI model (e.g., generative model, large language model, machine-learning model) (hereinafter the “synthetic data generation platform”). The synthetic data generation platform can use a dataset, which includes actual data comprising a set of attributes and/or a set of observed values for these attributes, to identify a subset of the attributes to be anonymized and/or depersonalized within the dataset (e.g., user identifiers such as name, address, etc., passwords, and so forth). Once the subset of attributes to be anonymized and/or depersonalized is identified, the synthetic data generation platform can generate a set of synthetic values for the attributes. Synthetic values can be generated directly from the actual data, with built-in provisions to anonymize and/or depersonalize the data during the creation process. The synthetic data generation platform can ensure that the synthetic data maintains the statistical properties and patterns of the original dataset while maintaining individual privacy.

In some implementations, synthetic data generation platform can first anonymize and/or depersonalize the actual data by, for example, removing any personal information. Once the data is anonymized and/or depersonalized, synthetic values are created from the depersonalized dataset. The two-step approach ensures that the synthetic data is derived from a dataset that has already been stripped of sensitive information, thereby lowering the risk of re-identification via reengineering. Additionally or alternatively, the synthetic data generation platform can create a reusable mask for depersonalizing the observed values. The mask can be saved and subsequently applied to other data (e.g., data that is similar to the original data, the original data itself, different data, and so forth). By creating and saving a depersonalization mask, the synthetic data generation platform can consistently anonymize/depersonalize across multiple datasets.

One of the advantages of the synthetic data generated off of depersonalized/anonymized data is that the synthetic data cannot be reverse-engineered. Unlike depersonalized or anonymized data, which can potentially be re-identified when combined with other databases or sources, by first depersonalizing or anonymizing the actual data and then creating synthetic data from it, the synthetic data generation platform ensures that the synthetic data cannot be traced back to the PII of the original customers. Thus, the synthetic data generation platform alleviates significant privacy regulatory concerns, as it prevents the possibility of re-engineering the synthetic data to uncover sensitive information of the clients.

However, for situations where the underlying real-world data includes complex relationships or interdependencies, even synthetic data informed by statistical patterns can fail, particularly in situations where entities within the data and relationships thereof are dynamic. For example, where entities are added or removed, the underlying data does not include indications of how such entities behave or influence other parts of the system. Conventional approaches to synthetic data generation can generate synthetic data that appears statistically valid at the individual entity level but can fail at capturing the intricate web of interdependencies between entities in more complex systems. This limitation can become particularly pronounced in dynamic environments where the relationship structure evolves over time, as the synthetic data generation process may not account for emergent relationships or changing entity hierarchies that were not present in the original training data.

Moreover, conventionally generated synthetic data can lose temporal coherence as such systems may not consider time-resolved or time-series information. Traditional synthetic data generation approaches often treat data points as independent observations without accounting for temporal dependencies and sequential relationships. As such, conventional synthetic data generation systems can fail to preserve the natural progression of events, seasonal patterns, or causal sequences present in real-world data, even when they account for static statistical distributions satisfactorily. The loss of temporal coherence can significantly impact the utility of synthetic data for applications that rely on understanding time-based behaviors, trends, or predictive patterns.

Furthermore, conventional systems for the generation of synthetic data are often not scalable, as complex relationships across increasingly large systems can be difficult to capture and/or track. Such conventional systems require training data (e.g., the underlying real-world data) to capture all relationships, such that accuracy can be limited by model complexity. As the number of entities and their latent or explicit interconnections grow, traditional approaches can struggle to maintain computational efficiency while preserving the full spectrum of relationships. The scalability challenge can be compounded by the exponential growth in relationship complexity as system size increases, leading to oversimplified synthetic data that lacks important relationships or to computationally prohibitive generation processes that cannot handle large-scale datasets.

Even conventional systems that account for interdependencies or relationships between entities (e.g., different data sources, datasets, or associated values) often handle the relationships as distinct from statistical relationships and patterns within the data. For example, synthetic data generated based on explicitly defined relationships between components of the real-world data can fail to capture latent structural relationships between entities. As such, the separation between structural and statistical modeling in conventional approaches can result in synthetic data that preserves the structural integrity or the statistical properties of the real-world data asymmetrically and inconsistently (e.g., by missing or relaxing strong, latent relationships between entities), thereby leading to synthetic datasets that appear structurally sound but exhibit statistical anomalies or, conversely, maintain statistical fidelity while violating suitable structural constraints.

Furthermore, conventional systems that model structural relationships between values, entities, or nodes within the data to be simulated often do not represent such relationships in a sufficiently flexible manner (e.g., for more complex relationship types). For example, conventional approaches can be limited to binary connections or predefined relationship categories, failing to capture nuanced, multi-dimensional, and context-dependent relationships that exist in real-world data. The inflexibility of such systems can result in synthetic data that oversimplifies complex relationship dynamics, leading to missing more complex patterns, including non-linear or conditional dependencies, hierarchical relationships, or relationships that vary based on temporal or contextual factors.

To address these further technical challenges, the inventors have also developed systems and methods for generating synthetic data based on ontological structures, such as knowledge networks, to account for complex relationships or interdependencies within the underlying data. For example, the disclosed data simulation platform leverages bidirectional integration of structural and statistical modelling to detect and enhance knowledge of relationships between entities, data structures, values, or other suitable data associated with the system. As such, the disclosed technology enables generation of more accurate synthetic data for validation and testing of computational models, such as artificial intelligence models, in situations where testing or training data is not available (e.g., due to security or privacy constraints) and where relationships between various components of the underlying data are complex and/or non-linear.

In some aspects, the data simulation platform can receive a node dataset that includes information relating to the structure of the underlying data to be simulated (e.g., a set of personal identifying information (PII)). The node dataset can include one or more datasets, data objects, structures, or other suitable data (e.g., entities or nodes), as well as one or more relationships characterizing relationships between such entities, represented in the form of a knowledge network. As an illustrative example, a large distributed software system can include a network of microservices (e.g., in a containerized architecture, such as in a Kubernetes system), each representing a node in a distributed architecture. Each microservice (e.g., a type of node) can be associated with a service type, version, deployment region, and/or associated resource usage statistics. The relationships (e.g., edges) between microservices can represent API calls, data flows, dependency links and can be associated with relationship attributes, including call frequency, latency, and/or authentication requirements. By receiving the node dataset information, the data simulation platform enables simulation of complex data structures and relationships thereof, thereby improving the flexibility of the data generation platform in its ability to handle different types of data, objects, and complex interdependencies.

Subsequently, the data simulation platform can analyze the node dataset (e.g., the received knowledge network) to extract statistical information (e.g., statistical metrics) associated with the relationships, values, and/or other attributes of the node dataset. For example, the data simulation platform can provide the node dataset representing relationships between microservices of the distributed system to a statistical inference model to generate inferred statistics (e.g., predicted values characterizing statistical metrics, such as average call latency, the distribution of service dependencies, API call volumes associated with particular microservices, and/or other suitable information). In some implementations, the inferred statistical dataset includes values that characterize relationships or interdependencies between multiple values, objects, or entities of the node dataset (e.g., within a particular node of the node dataset and/or between different nodes of the node dataset). To illustrate, the inferred statistical dataset includes a correlation coefficient that characterizes a similarity between API call latency values between two adjacent (and/or non-adjacent) microservices within the distributed system. Additionally or alternatively, the inferred statistical dataset includes an average value, variance value, and/or other suitable metrics associated with one or more attributes of particular microservices and/or relationships thereof.

In some implementations, the data simulation platform can model temporal patterns associated with a time series of the node dataset, knowledge network, or components thereof. For example, the data simulation platform leverages multiscale attention, hierarchical encodings, neural Hawkes processes, and/or temporal point processes to model sequences, enabling generation of temporal dependency graphs. By doing so, the data simulation platform enables both static and dynamic retention of complex interrelationships and patterns, thereby improving the resilience of the data simulation platform in generating synthetic data in complex and dynamic situations and environments.

The data simulation platform disclosed herein can leverage the inferred statistical dataset to update, improve, and/or infer a knowledge network that represents attributes or relationships within the associated system. For example, in the context of a distributed software system, the data simulation platform can identify previously unknown dependencies between microservices, detect latent communication patterns between system components, or discover implicit hierarchical relationships within data structures based on statistical correlations and usage patterns. The bidirectional enhancement between statistical analysis and knowledge network construction enables the generation of synthetic data that preserves both explicit structural relationships and implicit statistical dependencies that may not be apparent from examining either the graph structure or the associated statistical properties in isolation.

Based on the inferred entity-relationship network, the data simulation platform can generate a set of constraints to impose on subsequent generation of synthetic data. For example, the data simulation platform can determine, categorize, or evaluate relationships and values associated with the inferred entity-relationship network and generate a data structure that characterizes constraints to be imposed on the generation of data. In the context of a distributed software system, the data simulation platform can determine that data associated with particular microservices is to be correlated within a particular threshold or tolerance based on the nature of the inferred entity-relationship network (and/or associated inferred statistical data). By generating and subsequently imposing the set of constraints, the data simulation platform can ensure that synthetic data maintains structural integrity and statistical fidelity with respect to the real-world system, while preventing the generation of unrealistic or invalid data combinations that would violate the underlying system architecture and/or operational dependencies.

As such, the data simulation platform can generate the simulated node dataset such that it is consistent with the set of constraints and the inferred entity-relationship network (e.g., using one or more data generation models, as in a generative model suite). As an illustrative example, the data simulation platform generates synthetic data (e.g., simulated usage data associated with API calls between different microservices of the distributed system), where the associated attributes and relationships follow the determined constraints. For example, the synthetic data generated by the data simulation platform is such that API calls originating from one microservice are correlated with API calls received at another microservice within a particular tolerance, as determined based on the inferred statistical dataset. By doing so, the data simulation platform enables realistic testing and validation of distributed systems without exposing sensitive production data, while maintaining complex interdependencies and behavioral patterns that are valuable for accurate performance modeling and system optimization.

In some aspects, the data simulation platform can transmit the synthetic data to a suitable device for training or testing (e.g., of an artificial intelligence model). For example, the data simulation platform provides the simulated node dataset to development environments for load testing of distributed systems. The data simulation platform can convert or transmit the synthetic data in formats compatible with the target systems, such as structured datasets for database testing, API call logs for performance analysis, or streaming data for real-time system validation, thereby enabling comprehensive testing and model training without compromising the security or privacy of actual production data.

As such, the disclosed data simulation platform addresses limitations of conventional systems that fail to capture complex relationships and interdependencies by implementing a bidirectional integration approach between statistical and structural modeling. Unlike traditional methods that treat structural relationships and statistical properties as separate concerns, the disclosed platform can leverage knowledge networks to represent entity relationships, while simultaneously using statistical inference models to discover latent patterns and dependencies. The integrated approach described herein enables the system to identify previously unknown relationships between entities (e.g., microservices in a distributed system) and to generate synthetic data that preserves both explicit structural connections and implicit statistical correlations that emerge from underlying data patterns.

The data simulation platform can mitigate temporal coherence limitations associated with conventional approaches as the platform can employ specialized generative models that enable decomposition of data generation based on the knowledge network structure, enabling different specialized models (e.g., as part of a model suite) to process particular portions of data while maintaining overall consistency with the knowledge network. The approach enables the platform to scale efficiently as system complexity grows by leveraging hierarchical and modular data generation. As an illustrative example, the data simulation platform can use a flexible, rich, modular constraint and/or relationship embedding mechanism, enabling representation of multi-dimensional relationships within the inferred entity-relationship network. As such, the data simulation platform can handle complex relationship types within the real-world data beyond binary connections by encoding relationship attributes, conditional dependencies, and contextual factors directly within the knowledge network structure. The constraint generation process can thus handle hierarchical relationships, multi-hop dependencies, and context-dependent connections, enabling the synthetic data to capture nuanced relationship dynamics that vary based on operational (and/or temporal) factors. The flexibility improves the richness and accuracy of the synthetic data, thereby enabling testing and validation of systems where manipulation or transmission of sensitive data is limited.

Moreover, to assess the accuracy and fidelity of the synthetic data, the synthetic data generation platform can generate a tracking relationship value (e.g., a tracking difference, a tracking error, a tracking differentiator, tracking overlap percentage, or the like) between the original data (e.g., actual data, anonymized data, depersonalized data, and so forth) and the synthetic data. The tracking relationship value is a quantifiable metric comparing the synthetic data against the actual data across various scopes (e.g., at a variable level, at a segment—or group of variables—level, at an overall dataset level, and so forth). For example, if a user requests Kansas City credit card data from the last 48 hours, the synthetic data generation platform can not only generate synthetic data but also output that the synthetic data is within, for example, 1% of the actual data overall. Furthermore, the synthetic data generation platform can provide specific tracking relationship values for individual characteristics, such as, for example, a 0.1% tracking error for the “age” characteristic and/or a 2% tracking error for the “income” characteristic. This level of detailed comparison ensures that the synthetic data closely mirrors the actual data, making the synthetic data commercially scalable and highly reliable for various applications.

The tracking relationship value can be calculated by comparing the observed values of the identified subset of attributes with the corresponding synthetic values. The comparison can be performed against one or more benchmarks (e.g., certain variables to compare), providing a quantifiable metric that indicates how closely the synthetic data mirrors the real-world data. The benchmarks can be determined using an associated scenario (e.g., application domain) of the dataset. For example, in a financial field, the variables gender, income, geographical location, and so forth can be included in the benchmarks. If the tracking relationship value exceeds a certain threshold (e.g., specified by the user, specified by a guideline, dynamically generated), the synthetic data generation platform can regenerate the synthetic values using, for example, different parameters or weights. The threshold can be a threshold value, a threshold condition, a range of threshold values, and so forth.

By comparing the synthetic values with the observed values against established benchmarks, the synthetic data generation platform can quantify how closely the synthetic data mirrors the real-world data. Additionally, regenerating synthetic values if the tracking relationship value exceeds a certain threshold mitigates the risk of over-reliance on synthetic data. Furthermore, the synthetic data generation platform can ensure compliance with varying guidelines by providing a quantifiable method for assessing and validating synthetic data, thus simplifying the process of obtaining cross-border approval and accelerating the deployment of models trained on synthetic data.

While the current description provides examples related to LLMs, one of skill in the art would understand that the disclosed techniques can apply to other forms of machine learning or algorithms, including unsupervised, semi-supervised, supervised, and/or reinforcement learning techniques. For example, the disclosed intent-based data generation platform can evaluate model outputs from support vector machine (SVM), k-nearest neighbor (KNN), decision-making, linear regression, random forest, naïve Bayes, or logistic regression algorithms, and/or other suitable computational models.

In the following description, for the purposes of explanation, numerous specific details are set forth in order to provide a thorough understanding of implementations of the present technology. It will be apparent, however, to one skilled in the art that implementation of the present technology can be practiced without some of these specific details.

The phrases “in some implementations,” “in several implementations,” “according to some implementations,” “in the implementations shown,” “in other implementations,” and the like generally mean the specific feature, structure, or characteristic following the phrase is included in at least one implementation of the present technology and can be included in more than one implementation. In addition, such phrases do not necessarily refer to the same implementations or different implementations.

### Example Implementations of the Synthetic Data Generation Platform

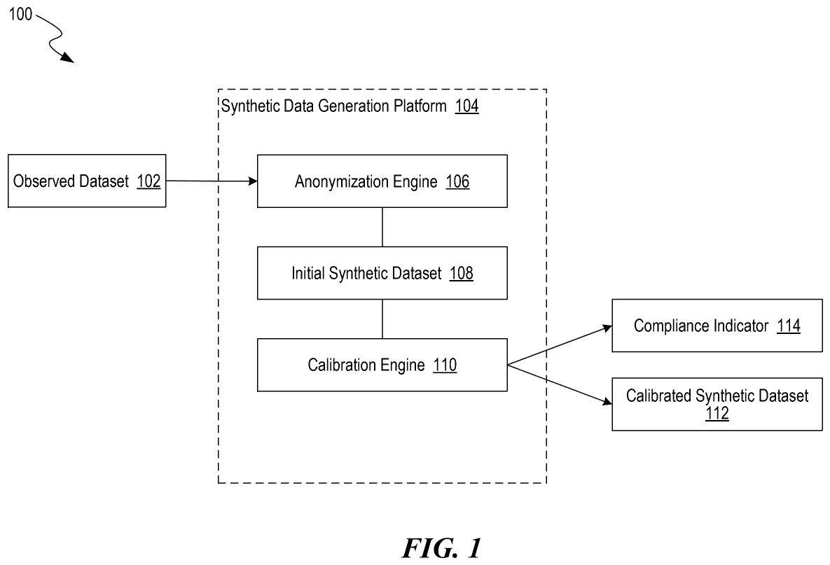

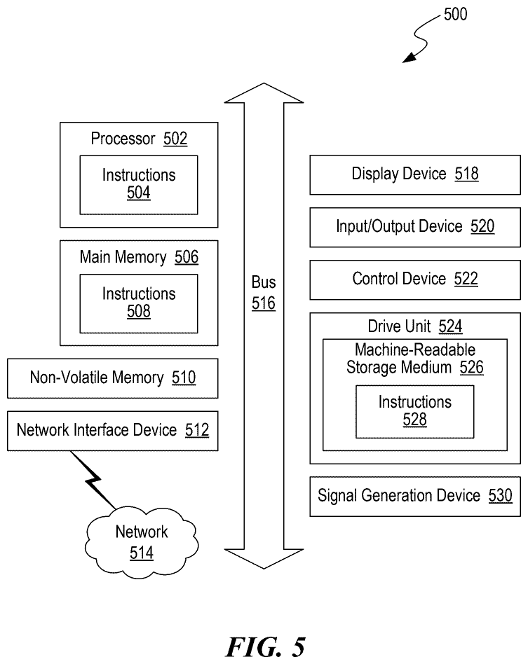

FIG. 1 illustrates an example environment 100 of a synthetic data generation platform 104 for generating synthetic data. The environment 100 includes an observed dataset 102 (e.g., data associated with actual data), the synthetic data generation platform 104, calibrated synthetic dataset 112, and compliance indicator 114. The synthetic data generation platform 104 can include anonymization engine 106, which can output initial synthetic dataset 108, and calibration engine 110. The synthetic data generation platform 104 is implemented using components of the example computer system 500 illustrated and described in more detail with reference to FIG. 5. Implementations of the environment 100 can include different and/or additional components or can be connected in different ways.

The observed dataset 102 refers to data associated with the original data and/or actual data collected from real-world sources (e.g., the original/actual data, copies of the original/actual data, data generating using the original/actual data, and so forth), which may contain sensitive information such as personal information. The observed dataset 102 serves as the input for the synthetic data generation platform 104. In some implementations, the observed dataset 102 can be multimodal, text, computer data, code, audio, image, video, and so forth. The synthetic data generation platform 104 is a computer system (e.g., computer system 500) that generates synthetic datasets to mimic and/or replicate one or more properties or representations (e.g., statistical properties) of the observed dataset 102 while ensuring that the synthetic data cannot be traced back to the original data. Thus, the synthetic data generation platform 104 is enabled to ensure compliance with guidelines and/or regulatory frameworks that define how personal data is to be handled, stored, shared, and so forth (e.g., guidelines that restrict the transfer of personal data across borders unless certain conditions are met). By generating synthetic data that mimics the statistical properties of the observed dataset, the synthetic data generation platform 104 can anonymize and/or depersonalize information based on the guidelines for different geographical locations or entities. In some implementations, the synthetic data generation platform 104 can be integrated with cloud-based services and/or be executed from local server.

The anonymization engine 106 within the synthetic data generation platform 104 transforms data within the observed dataset 102 into synthetic data values of the initial synthetic dataset 108 by anonymizing and/or depersonalizing the data. The anonymization engine 106 can apply one or more anonymization methods to ensure that the synthetic data does not contain any personal information. The initial synthetic dataset 108 refers to the output generated by the anonymization engine 106. Anonymization and depersonalization refer to transforming data such that one or more entities to whom the data pertains cannot be identified, either directly or indirectly (e.g., a certain user identifier, an Internet Protocol address, and so forth). Anonymization and depersonalization can include data masking (i.e., where sensitive information is replaced with random characters or symbols), pseudonymization (i.e., where identifiers are replaced with pseudonyms), and generalization (i.e., where detailed data is replaced with broader categories), and so forth.

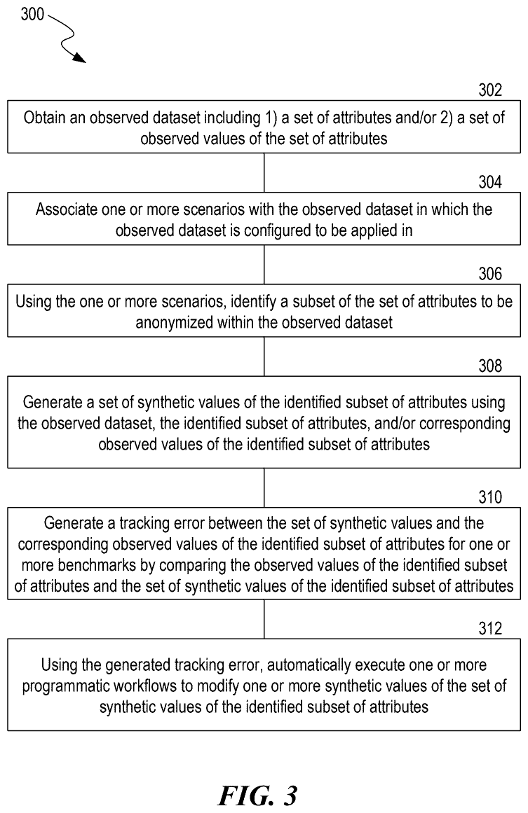

For text data, the synthetic data generation platform 104 can anonymize and/or depersonalize sensitive information in documents, emails, and other textual content/sources while preserving the context and/or structure of the text. For audio data, the synthetic data generation platform 104 can generate synthetic audio files that maintain the acoustic properties (e.g., pitch, tone, rhythm) of the original recordings. With image data, the synthetic data generation platform 104 can create synthetic images that replicate the visual characteristics (e.g., color distribution, texture, spatial relationships) of the original images. Similarly, for video data, the platform can generate synthetic videos that retain the temporal and spatial properties (e.g., same motion patterns, lighting conditions) of the original footage. Further examples of generated synthetic data are discussed with reference to FIG. 3.

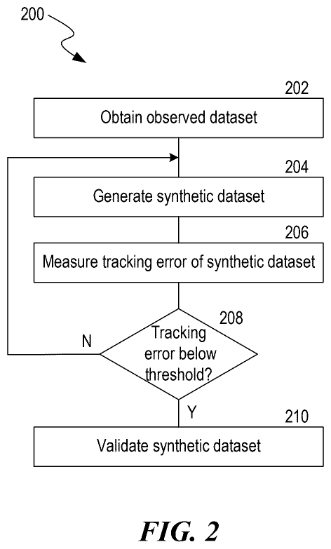

In some implementations, the initial synthetic dataset 108 can be evaluated against one or more calibration (e.g., validation) checks to ensure that the initial synthetic dataset 108 satisfies one or more criteria (e.g., benchmarks such as statistical similarity to the observed dataset, preservation of data distributions, compliance with guidelines, and so forth) before being output from the synthetic data generation platform 104. For example, the calibration engine 110 can validate that the initial synthetic dataset 108 has a tracking relationship value below a certain threshold using methods discussed with reference to FIG. 2. The calibration engine 110 refines the initial synthetic dataset 108 to produce a calibrated synthetic dataset 112. In some implementations, the calibration engine 110 can use machine learning algorithms to iteratively adjust the initial synthetic dataset 108.

The synthetic data generation platform 104 can generate a compliance indicator 114 (e.g., an audit, a compliance report, and so forth) of observed dataset 102, which can be an artifact (e.g., text document, image, video, audio) generated by the synthetic data generation platform 104 that indicates the synthetic data's compliance with one or more guidelines (e.g., privacy regulations). The compliance indicator 114 can include metrics such as a tracking relationship value determined using methods discussed with reference to FIG. 2 and FIG. 3.

FIG. 2 is a block diagram illustrating an example process 200 performed by the calibration engine of the synthetic data generation platform 104 of FIG. 1 for generating a measurable tracking relationship value of the generated synthetic data. The calibration engine can be implemented on a terminal device, a server, or on a telecommunications network core. Implementations can include different and/or additional blocks or can perform the operations of the blocks in different orders.

In block 202, the synthetic data generation platform 104 can obtain an observed dataset (e.g., observed dataset 102 in FIG. 1). Users can input the observed dataset directly into the synthetic data generation platform 104 (e.g., by uploading files in formats such as CSV, JSON, Excel, and so forth). In some implementations, the synthetic data generation platform 104 can schedule regular data imports from specified sources at specified intervals (e.g., daily, weekly). Additionally, the synthetic data generation platform 104 can integrate with external systems and databases through Application Programming Interface (API) calls, allowing the synthetic data generation platform 104 to obtain data programmatically.

In block 204, the synthetic data generation platform 104 can generate a synthetic dataset (e.g., initial synthetic dataset 108 in FIG. 1). The synthetic dataset is an artificially generated dataset that mirrors the statistical properties, patterns, and characteristics of the observed dataset. For example, the synthetic data generation platform 104 can use one or more non-generative or generative models to generate the synthetic dataset. In some implementations, the synthetic dataset can be generated using machine learning models that are trained on the observed dataset. The models can learn the underlying patterns and relationships in the data and use the underlying patterns and relationships to generate new, synthetic data points that maintain similar statistical properties as the observed dataset. Further methods of generating the synthetic dataset are discussed with reference to FIG. 3.

In block 206, the synthetic data generation platform 104 can measure a tracking relationship value of one or more portions of the synthetic dataset (e.g., a specific characteristic, a group of characteristics, the entire dataset, and so forth). The tracking relationship value is a quantifiable metric. The tracking relationship value may be used to assess the fidelity and/or reliability of the synthetic dataset. The tracking relationship value can measure the difference between the synthetic dataset and the observed dataset to evaluate how accurately the synthetic data reflects the real-world conditions represented by the original data. In some implementations, the tracking relationship value can be calculated using statistical methods such as mean squared error or other distance metrics. For example, the synthetic data generation platform 104 can compare the distributions of the observed and synthetic datasets to determine a degree of similarity between them. Further methods of measuring the tracking relationship value are discussed with reference to FIG. 3.

In block 208, the synthetic data generation platform 104 determines whether the tracking relationship value is below a threshold (e.g., a predefined error value). The threshold is a predefined value that serves as a benchmark for, for example, the acceptable level of tracking error. If the tracking error of the synthetic dataset is below the threshold, it indicates that the synthetic data is sufficiently accurate. In some implementations, the threshold can be dynamically adjusted based on the specific context of the application or the sensitivity of the data.

If the tracking relationship value is below the threshold, the synthetic data generation platform 104 validates the synthetic dataset in block 210. If the tracking relationship value is below the threshold, the synthetic data generation platform 104 regenerates the synthetic dataset by proceeding back to block 204. In some implementations, the synthetic data generation platform 104 can use different algorithms or parameters to generate the synthetic dataset. Additionally, the synthetic data generation platform 104 can adjust hyperparameters, such as learning rates or batch sizes, to improve the performance of the generative models. The synthetic data generation platform 104 can iteratively generate new synthetic datasets, measure their tracking relationship values, and refine the data until the tracking relationship value falls below the acceptable threshold.

In some implementations, the synthetic data generation platform 104 can be used to obtain cross-border approval for actual data using the generated synthetic dataset. For example, the synthetic dataset can be used to demonstrate compliance in one or more scenarios (e.g., an application domain, a target application, a particular location, a particular use case, a particular regulation, such as the European Union's General Data Protection Regulation (GDPR)). To ensure the synthetic data is a reliable proxy for the actual data and complies with applicable regulations associated with cross-border approval, the synthetic data generation platform 104 can compute the deviation between the actual and synthetic data (e.g., block 208). The synthetic data generation platform 104 can measure the statistical differences between the two datasets, such as mean, variance, and distribution, and so forth. In some implementations, the synthetic data generation platform 104 can evaluate the generated synthetic dataset against one or more benchmarks (e.g., criteria in privacy regulations). If the deviation between the actual and synthetic data exceeds a certain threshold, which may indicate a risk of re-identification the synthetic data generation platform 104 can adjust the synthetic dataset to comply with local regulations.

FIG. 3 is a flow diagram illustrating an example process of generating calibrated synthetic data using the synthetic data generation platform 104 of FIG. 1. The synthetic data generation platform 104 can be implemented on a terminal device, a server, or on a telecommunications network core. Implementations can include different and/or additional operations or can perform the operations in different orders.

In operation 302, the synthetic data generation platform 104 can obtain (e.g., from a computing device), an observed dataset (e.g., actual data) including 1) a set of attributes and/or 2) a set of observed values of the set of attributes. In some implementations, the synthetic data generation platform 104 can obtain the observed dataset directly from a computing device, such as a user's local machine, a server, or a cloud storage service. Further examples of observed datasets and methods of obtaining the observed dataset are discussed with reference to FIG. 2.

In operation 304, the synthetic data generation platform 104 can associate (e.g., link, map) one or more scenarios (e.g., application domains, applications, use cases, contexts, conditions, operational domains) with the observed dataset in which the dataset is configured to be applied in. The scenarios refer to specific contexts or use cases in which the observed dataset is intended to be used. In some implementations, scenarios can indicate a degree of sensitivity (e.g., highly confidential), operational domain (e.g., finance, healthcare), guideline (e.g., privacy regulation), and so forth. For example, users can classify the dataset based on its sensitivity level, such as public, internal, confidential, or highly confidential, to specify the level of data anonymization used when generating the synthetic data.

In operation 306, the synthetic data generation platform 104 can identify (e.g., associate, link, map) a subset of the set of attributes to be anonymized and/or depersonalized within the observed dataset (e.g., using the scenarios). The subset of attributes refers to specific data fields within the observed dataset that are selected for anonymization. In some implementations, the users can manually select the attributes to be anonymized and/or depersonalized.

In some implementations, the synthetic data generation platform 104 can automatically identify the subset of attributes to be anonymized and/or depersonalized based on predefined rules or machine learning models. For example, the rules can be derived from privacy regulations, organizational policies, or other guidelines that specify one or more data types to be anonymized and/or depersonalized. In some implementations, one or more machine learning (ML) models can be trained to recognize sensitive attributes by identify patterns in the data and identifying fields that are likely to contain personal information. For example, the ML models can use the format of the data (e.g., patterns of digits and letters), the presence of special characters (e.g., “@” in email addresses), the length of the data, the context in which the data appears (e.g., column names or surrounding text), and so forth to identify the patterns.

The subset of attributes can be, for example, a single variable/characteristic, a segment (e.g., a group of variables), and/or all attributes of the set of attributes. Each attribute of the segment can share a common attribute identifier. The attribute identifier can be, for example, an application domain (e.g., finance, health), an operational context (e.g., verification, audit), a user role (e.g., customer, administrator), and so forth. In some implementations, the identified subset of attributes is specified by a user of a computing device. The user can instruct the synthetic data generation platform 104 to generate a set of synthetic data for a particular combination of attributes. For instance, the synthetic data generation platform 104 can implement a graphical user interface (GUI) with checkboxes, dropdown menus, and search functionalities that enables the user to navigate through the available attributes and select one or more.

In operation 308, the synthetic data generation platform 104 can generate (e.g., using a first set of AI models) a set of synthetic values of the identified subset of attributes using the observed dataset, the identified subset of attributes, and/or corresponding observed values of the identified subset of attributes. The synthetic values are artificially generated data points that replace the original values in the identified subset of attributes.

In some implementations, the synthetic values are generated directly from the actual data, with built-in provisions to anonymize and/or depersonalize the data during the creation process. The synthetic values can be, for example, a number, a sequence of numbers, or digital data satisfying one or more statistical tests for randomness (e.g., Kolmogorov-Smirnov test, entropy, and so forth) but produced by a definite mathematical procedure (e.g., data masking, pseudonymization, generalization). For example, the synthetic data generation platform 104 can replace sensitive data elements (i.e., observed values of the identified subset of attributes) with random characters or symbols, replace identifiers with pseudonyms, and/or replace detailed data with broader categories (e.g., replacing specific ages with age ranges).

In some implementations, the synthetic data generation platform 104 can first anonymize and/or depersonalize the actual data by, for example, removing any personal information. Once the data is anonymized and/or depersonalized, synthetic values can be created from the depersonalized dataset. In this manner, the synthetic values generated are unable to be reverse-engineered and are more likely to comply with various data privacy regulations.

Additionally, the synthetic data generation platform 104 can create a mask for anonymizing and/or depersonalizing the observed values. The mask can be saved and subsequently applied to other data (e.g., data that is similar to the original data, the original data itself, different data, and so forth). For example, the synthetic data generation platform 104 can define a set of transformation rules applicable across datasets. For example, a rule for names can specify that all values in the column “Names” are replaced with random strings of characters, names from a predefined list, and so forth. Once the transformation rules are defined, the transformation rules can be saved as part of the anonymization/depersonalization mask. The mask can be versioned to keep track of changes or updates to the transformation rules. The saved mask can be applied to other datasets. For example, if a new dataset is collected that contains similar types of data, the anonymization/depersonalization mask can be applied to transform the identified attributes according to the predefined rules.

In some implementations, the synthetic data generation platform 104 can identify the distribution and characteristics of the observed data and generate synthetic values that follow the same or similar patterns. For example, if the original dataset contains ages that are normally distributed, the synthetic data generation platform 104 can generate synthetic ages that follow a similar normal distribution with a similar variance and/or mean. Additionally or alternatively, the synthetic data generation platform 104 can identify the relationships between different attributes in the observed dataset and generate synthetic values that maintain the relationships. To preserve correlations between variables in the synthetic data, the synthetic data generation platform 104 can calculate the correlation coefficient between the attributes in the observed dataset. For example, if the synthetic data generation platform 104 determines that age and income have a correlation coefficient of 0.7, the synthetic data generation platform 104 can generate synthetic values for age and income so that the synthetic data exhibits a similar correlation coefficient. In some implementations, synthetic values can be generated using machine models such as generative adversarial networks (GANs). GANs consist of two neural networks, a generator and a discriminator, that can be trained together in an adversarial manner. The generator can create synthetic data, while the discriminator can evaluate the quality of the synthetic data by comparing it to the original data.

In operation 310, the synthetic data generation platform 104 can generate (e.g., via a second set of AI models that are the same as or different from the first set of AI models) a tracking relationship value between the set of synthetic data and the observed dataset for one or more benchmarks by comparing the observed values of the identified subset of attributes and the set of synthetic values of the identified subset of attributes. In some implementations, the synthetic data generation platform 104 can calculate the tracking relationship value by determining whether the correlation between attributes in the synthetic data is within a certain threshold of the correlation in the observed data.

Additionally, the tracking relationship value can be generated by comparing the synthetic data against particular guidelines (e.g., a particular country's privacy regulations) or benchmarks (e.g., statistical properties of certain variables such as gender, income, geographic location, zip codes, and so forth). The synthetic data generation platform 104 can evaluate whether the distribution of synthetic values matches the distribution of observed values. For example, benchmarks can include gender, where the platform ensures that the distribution of gender in the synthetic data matches the observed data to preserve the proportion of male and female individuals. The synthetic data generation platform 104 can use statistical tests (e.g., mean absolute error, mean squared error, and so forth) to determine if the differences between the observed and synthetic data are beyond a certain threshold. In some implementations, the synthetic data generation platform 104 can evaluate the preservation of higher-order relationships, such as interactions between multiple attributes, to ensure that the synthetic data captures the complexity of the original dataset.

In some implementations, the synthetic data generation platform 104 can aggregate all benchmarks and calculate a weighted average. The synthetic data generation platform 104 can assign different weights to each benchmark based on their importance or relevance to the specific scenario (e.g., the associated scenario defines a set of weights for the set of benchmarks). For instance, in a healthcare dataset, benchmarks related to patient demographics can be given higher weights compared to other attributes. By calculating a weighted average of the tracking relationship values for each benchmark, the synthetic data generation platform 104 can measure the difference between the weighted average and a predefined threshold to generate the tracking relationship value.

In some implementations, the synthetic data generation platform 104 can group benchmarks together based on the benchmarks' characteristics and/or the relationships between the benchmarks. For example, benchmarks related to demographic attributes such as age, gender, and ethnicity can be grouped together, while benchmarks related to financial attributes such as income, expenditure, and credit score can form another group. By grouping benchmarks, the In some implementations, the synthetic data generation platform 104 can evaluate the synthetic data's quality within each group separately. For instance, if the tracking relationship value for the demographic group is high, the platform can apply programmatic workflows to adjust the synthetic values of demographic attributes while keeping the financial attributes unchanged.

The threshold can be dynamically adjusted based on scenario or set by the user. In some implementations, the synthetic data generation platform 104 dynamically adjusts the thresholds based on the associated scenario. For example, in a scenario where high accuracy is desired, such as in medical research, the thresholds can be set higher to ensure that the synthetic data more closely matches the observed data.

In some implementations, the tracking relationship value generated by the synthetic data generation platform 104 can indicate a degree of anonymization in the synthetic data. To measure and mitigate the risk of re-identification, the synthetic data generation platform 104 can validate that each record in the dataset is indistinguishable from at least other records with respect to certain identifying attributes. For example, the synthetic data generation platform 104 can identify quasi-identifiers-attributes that, when combined, can potentially identify individuals (e.g., age, gender, and zip code). The synthetic data generation platform 104 can group records that share the same values for these quasi-identifiers, ensuring that each group contains at least a certain number of records so that it is difficult to single out any individual record based on these attributes.

In operation 312, the synthetic data generation platform 104 can, using the generated tracking relationship value, automatically execute one or more programmatic workflows to modify one or more synthetic values of the set of synthetic values of the identified subset of attributes. The programmatic workflows can modify the synthetic values using methods such as re-sampling, re-weighting, or applying transformation functions to better align certain characteristics of the synthetic data (e.g., correlation, distribution, and so forth) with the observed data. The synthetic data generation platform 104 can iteratively adjusting one or more of: 1) weights, 2) biases, or 3) activation functions of the AI models used to generate the synthetic values to reduce the tracking relationship value. In some implementations, the programmatic workflows are rule-based adjustments, where the synthetic data generation platform 104 applies predefined rules to modify the synthetic values based on the tracking relationship value. For instance, if the tracking relationship value indicates that the synthetic data has a higher variance than the observed data, the synthetic data generation platform 104 can apply a particular rule to scale down the synthetic values to reduce the variance.

In some implementations, the synthetic data generation platform 104 can determine whether the tracking relationship value satisfies a predetermined threshold of the one or more benchmarks. In response to the tracking relationship value failing to satisfy the predetermined threshold, the synthetic data generation platform 104 can regenerate the set of synthetic data. In response to the tracking relationship value satisfying the predetermined threshold, the synthetic data generation platform 104 can cause display of the set of synthetic data on the computing device. Further methods of regenerating the synthetic data are discussed with reference to FIG. 2.

### Example Implementation of the Models of the Synthetic Data Generation Platform

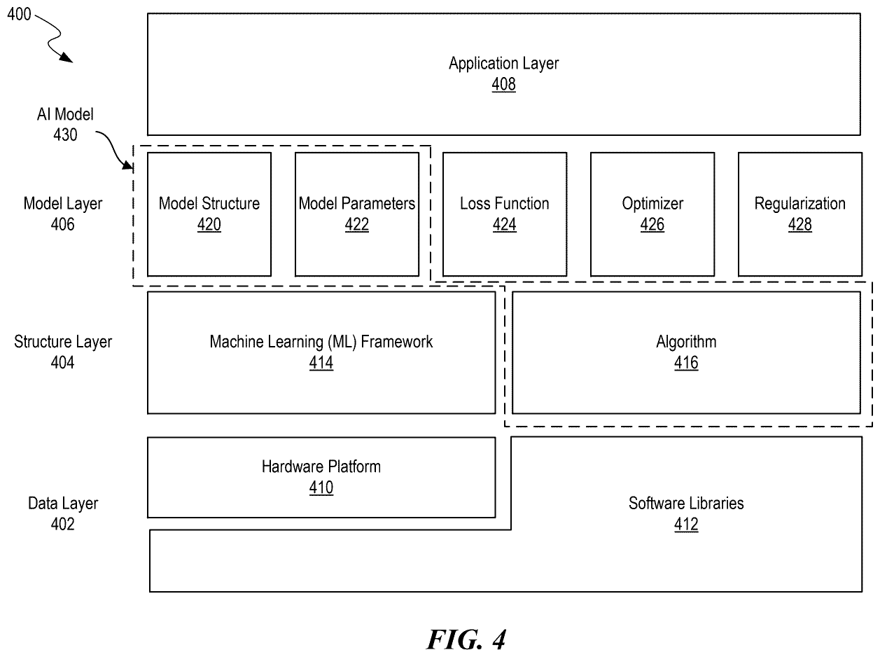

FIG. 4 illustrates a layered architecture of an AI system 400 that can implement the ML models of the synthetic data generation platform 104 of FIG. 1. Example ML models can include the models executed by the synthetic data generation platform 104, such as remediation models, anomaly detection models, and so forth. Accordingly, the AI models of the synthetic data generation platform can include one or more components of the AI system 400.

As shown, the AI system 400 can include a set of layers, which conceptually organize elements within an example network topology for the AI system's architecture to implement a particular AI model. Generally, an AI model is a computer-executable program implemented by the AI system 400 that analyses data to make predictions. Information can pass through each layer of the AI system 400 to generate outputs for the AI model. The layers can include a data layer 402, a structure layer 404, a model layer 406, and an application layer 408. The algorithm 416 of the structure layer 404 and the model structure 420 and model parameters 422 of the model layer 406 together form an example AI model. The optimizer 426, loss function engine 424, and regularization engine 428 work to refine and optimize the AI model, and the data layer 402 provides resources and support for application of the AI model by the application layer 408.

The data layer 402 acts as the foundation of the AI system 400 by preparing data for the AI model. As shown, the data layer 402 can include two sub-layers: a hardware platform 410 and one or more software libraries 412. The hardware platform 410 can be designed to perform operations for the AI model and include computing resources for storage, memory, logic and networking, such as the resources described in relation to FIG. 5. The hardware platform 410 can process amounts of data using one or more servers. The servers can perform backend operations such as matrix calculations, parallel calculations, machine learning (ML) training, and the like. Examples of servers used by the hardware platform 410 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 410 can include computing resources, (e.g., servers, memory, etc.) offered by a cloud services provider. The hardware platform 410 can also include computer memory for storing data about the AI model, application of the AI model, and training data for the AI model. The computer memory can be a form of random-access memory (RAM), such as dynamic RAM, static RAM, and non-volatile RAM.

The software libraries 412 can be thought of suites of data and programming code, including executables, used to control the computing resources of the hardware platform 410. The programming code can include low-level primitives (e.g., fundamental language elements) that form the foundation of one or more low-level programming languages, such that servers of the hardware platform 410 can use the low-level primitives to carry out specific operations. The low-level programming languages do not require much, if any, abstraction from a computing resource's instruction set architecture, enabling them to run quickly with a small memory footprint. Examples of software libraries 412 that can be included in the AI system 400 include INTEL Math Kernel Library, NVIDIA cuDNN, EIGEN, and OpenBLAS.

The structure layer 404 can include an ML framework 414 and an algorithm 416. The ML framework 414 can be thought of as an interface, library, or tool that enables users to build and deploy the AI model. The ML framework 414 can include an open-source library, an API, a gradient-boosting library, an ensemble method, and/or a deep learning toolkit that work with the layers of the AI system facilitate development of the AI model. For example, the ML framework 414 can distribute processes for application or training of the AI model across multiple resources in the hardware platform 410. The ML framework 414 can also include a set of pre-built components that have the functionality to implement and train the AI model and enable users to use pre-built functions and classes to construct and train the AI model. Thus, the ML framework 414 can be used to facilitate data engineering, development, hyperparameter tuning, testing, and training for the AI model. Examples of ML frameworks 414 that can be used in the AI system 400 include TENSORFLOW, PYTORCH, SCIKIT-LEARN, KERAS, LightGBM, RANDOM FOREST, and AMAZON WEB SERVICES.

The algorithm 416 can be an organized set of computer-executable operations used to generate output data from a set of input data and can be described using pseudocode. The algorithm 416 can include complex code that enables the computing resources to learn from new input data and create new/modified outputs based on what was learned. In some implementations, the algorithm 416 can build the AI model through being trained while running computing resources of the hardware platform 410. This training enables the algorithm 416 to make predictions or decisions without being explicitly programmed to do so. Once trained, the algorithm 416 can run at the computing resources as part of the AI model to make predictions or decisions, improve computing resource performance, or perform tasks. The algorithm 416 can be trained using supervised learning, unsupervised learning, semi-supervised learning, and/or reinforcement learning.

Using supervised learning, the algorithm 416 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include native-format data collected (e.g., in the form of dataset 102 in FIG. 1) from various source computing systems described in relation to FIG. 1. Furthermore, training data can include pre-processed data generated by various engines of the synthetic data generation platform 104 described in relation to FIG. 1. The user may label the training data based on one or more classes and trains the AI model by inputting the training data to the algorithm 416. The algorithm determines how to label the new data based on the labeled training data. The user can facilitate collection, labeling, and/or input via the ML framework 414. In some instances, the user may convert the training data to a set of feature vectors for input to the algorithm 416. Once trained, the user can test the algorithm 416 on new data to determine if the algorithm 416 is predicting accurate labels for the new data. For example, the user can use cross-validation methods to test the accuracy of the algorithm 416 and retrain the algorithm 416 on new training data if the results of the cross-validation are below an accuracy threshold.

Supervised learning can include classification and/or regression. Classification techniques include teaching the algorithm 416 to identify a category of new observations based on training data and are used when input data for the algorithm 416 is discrete. Said differently, when learning through classification techniques, the algorithm 416 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 416 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques include estimating relationships between independent and dependent variables and are used when input data to the algorithm 416 is continuous. Regression techniques can be used to train the algorithm 416 to predict or forecast relationships between variables. To train the algorithm 416 using regression techniques, a user can select a regression method for estimating the parameters of the model. The user collects and labels training data that is input to the algorithm 416 such that the algorithm 416 is trained to understand the relationship between data features and the dependent variable(s). Once trained, the algorithm 416 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 416 learns patterns from unlabeled training data. In particular, the algorithm 416 is trained to learn hidden patterns and insights of input data, which can be used for data exploration or for generating new data. Here, the algorithm 416 does not have a predefined output, unlike the labels output when the algorithm 416 is trained using supervised learning. Said another way, unsupervised learning is used to train the algorithm 416 to find an underlying structure of a set of data, group the data according to similarities, and represent that set of data in a compressed format. The synthetic data generation platform 104 can use unsupervised learning to identify patterns in claim history (e.g., to identify particular event sequences) and so forth. In some implementations, performance of the AI models of the data management platform that can use unsupervised learning is improved because the incoming dataset 102 is pre-processed and reduced, based on the relevant triggers, as described herein.

A few techniques can be used in supervised learning: clustering, anomaly detection, and techniques for learning latent variable models. Clustering techniques include grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 416 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 416 may be trained to be an Isolation Forest, local outlier factor (LOF) algorithm, or K-nearest neighbor (k-NN) algorithm. Latent variable techniques include relating observable variables to a set of latent variables. These techniques assume that the observable variables are the result of an individual's position on the latent variables and that the observable variables have nothing in common after controlling for the latent variables. Examples of latent variable techniques that may be used by the algorithm 416 include factor analysis, item response theory, latent profile analysis, and latent class analysis.

The model layer 406 implements the AI model using data from the data layer and the algorithm 416 and ML framework 414 from the structure layer 404, thus enabling decision-making capabilities of the AI system 400. The model layer 406 includes a model structure 420, model parameters 422, a loss function engine 424, an optimizer 426, and a regularization engine 428.

The model structure 420 describes the architecture of the AI model of the AI system 400. The model structure 420 defines the complexity of the pattern/relationship that the AI model expresses. Examples of structures that can be used as the model structure 420 include decision trees, support vector machines, regression analyses, Bayesian networks, Gaussian processes, genetic algorithms, and artificial neural networks (or, simply, neural networks). The model structure 420 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 420 may include one or more hidden layers of nodes between the input and output layers. The model structure 420 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 422 represent the relationships learned during training and can be used to make predictions and decisions based on input data. The model parameters 422 can weight and bias the nodes and connections of the model structure 420. For instance, when the model structure 420 is a neural network, the model parameters 422 can weight and bias the nodes in each layer of the neural networks, such that the weights determine the strength of the nodes and the biases determine the thresholds for the activation functions of each node. The model parameters 422, in conjunction with the activation functions of the nodes, determine how input data is transformed into desired outputs. The model parameters 422 can be determined and/or altered during training of the algorithm 416.

The loss function engine 424 can determine a loss function, which is a metric used to evaluate the AI model's performance during training. For instance, the loss function engine 424 can measure the difference between a predicted output of the AI model and the actual output of the AI model and is used to guide optimization of the AI model during training to minimize the loss function. The loss function may be presented via the ML framework 414, such that a user can determine whether to retrain or otherwise alter the algorithm 416 if the loss function is over a threshold. In some instances, the algorithm 416 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 426 adjusts the model parameters 422 to minimize the loss function during training of the algorithm 416. In other words, the optimizer 426 uses the loss function generated by the loss function engine 424 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 426 used may be determined based on the type of model structure 420 and the size of data and the computing resources available in the data layer 402.

The regularization engine 428 executes regularization operations. Regularization is a technique that prevents over-and under-fitting of the AI model. Overfitting occurs when the algorithm 416 is overly complex and too adapted to the training data, which can result in poor performance of the AI model. Underfitting occurs when the algorithm 416 is unable to recognize even basic patterns from the training data such that it cannot perform well on training data or on validation data. The optimizer 426 can apply one or more regularization techniques to fit the algorithm 416 to the training data properly, which helps constraint the resulting AI model and improves its ability for generalized application. Examples of regularization techniques include lasso (L1) regularization, ridge (L2) regularization, and elastic (L1 and L2 regularization).

The application layer 408 describes how the AI system 400 is used to solve problem or perform tasks. In an example implementation, the application layer 408 can include a front-end user interface of the synthetic data generation platform 104.

### Example Computing Environment of the Data Management Platform

FIG. 5 is a block diagram showing some of the components typically incorporated in at least some of the computer systems and other devices 500 on which the disclosed system operates. As shown, an example computer system 500 can include: one or more processors 502, main memory 508, non-volatile memory 512, a network interface device 514, video display device 520, an input/output device 522, a control device 524 (e.g., keyboard and pointing device), a drive unit 526 that includes a machine-readable medium 528, and a signal generation device 532 that are communicatively connected to a bus 518. The bus 518 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computer system 500 can share a similar architecture to that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 500. In some implementations, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 514 enables the computer system 500 to exchange data in a network 516 with an entity that is external to the computing system 500 through any communication protocol supported by the computer system 500 and the external entity. Examples of the network interface device 514 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 508, non-volatile memory 512, machine-readable medium 528) can be local, remote, or distributed. Although shown as a single medium, the machine-readable medium 528 can include multiple media (e.g., a centralized/distributed database and/or associated caches and servers) that store one or more sets of instructions 530. The machine-readable (storage) medium 528 can include any medium that is capable of storing, encoding, or carrying a set of instructions for execution by the computer system 500. The machine-readable medium 528 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 510, 530) set at various times in various memory and storage devices in computing device(s). When read and executed by the processor 502, the instruction(s) cause the computer system 500 to perform operations to execute elements involving the various aspects of the disclosure.

### Overview of the Data Simulation Platform

The data simulation platform disclosed herein enables generation of synthetic data that retains structural, statistical, and semantic relationships within the underlying real-world data. For example, the data simulation platform enables inference of statistical attributes of and relationships between various nodes of a financial transaction network (e.g., high-frequency trading entities, prime brokers, and/or trading desks of a trading network). Based on determination of explicit structural constraints within the data of the transaction network, as well as the inferred statistical attributes and relationships, the data simulation platform can generate accurate synthetic data, informed by patent and latent relationships between entities, that enables validation and training of related artificial intelligence models (e.g., credit scoring, risk-assessment, and algorithmic trading models) in compliance with data protection regulations.

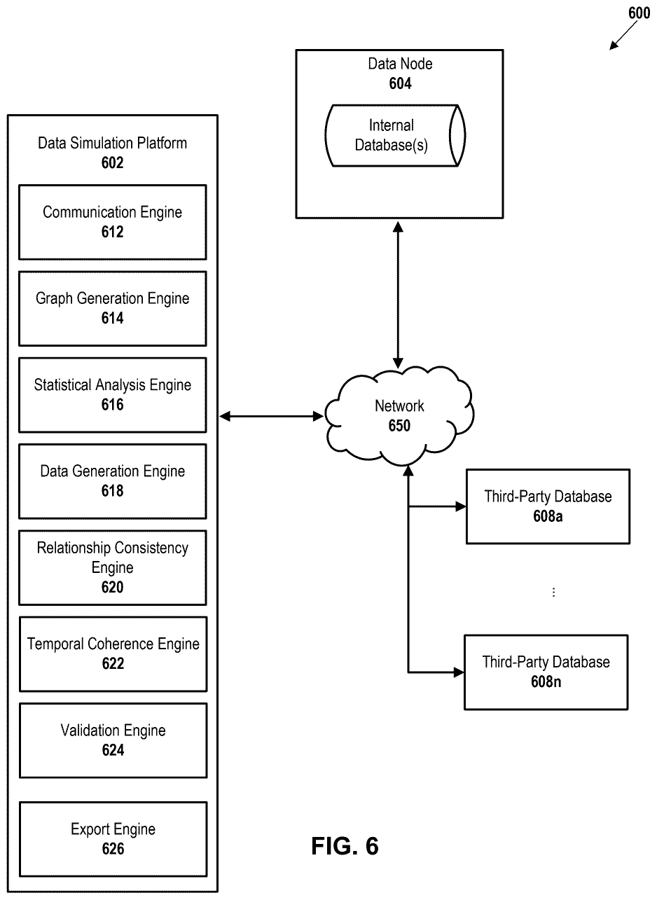

FIG. 6 illustrates an example environment 600 including a data simulation platform that enables generation of synthetic data based on an inferred entity-relationship network capturing structural, statistical, and semantic attributes, in accordance with one or more implementations of the disclosed technology. For example, the environment 600 includes the data simulation platform 602, which is capable of communicating with (e.g., transmitting or receiving data to or from) a data node 604 and/or third-party databases 604a-604n via a network 650. The data simulation platform 602 can include hardware, software, or a combination of both and can reside on a physical server or a virtual server running on a physical computing system. For example, the data simulation platform 602 is configured on a user device (e.g., a laptop computer, smartphone, desktop computer, electronic tablet, or another suitable user device). Furthermore, the data simulation platform 602 can reside on a server or node and/or can interface with third-party databases 608a-608n directly or indirectly. In some implementations, the data simulation platform 602 includes, processes, or generates suitable hardware or software components as described in relation to FIGS. 4 and 5 above.

The data simulation platform 602 can include one or more components, including a communication engine 612, a graph generation engine 614, a statistical analysis engine 616, a data generation engine 618, a relationship consistency engine 620, a temporal coherence engine 622, a validation engine 624, and/or an export engine 626. One or more components can execute one or more operations associated with the disclosed technology.

The data node 604 can store various data, including one or more machine learning models (e.g., LLMs, models associated with the statistical modeling or generative artificial intelligence suites, node maps (e.g., real-world data associated with decentralized networks, knowledge networks, inferred entity-relationship networks), embeddings associated with statistical relationships, structural relationships, or semantic relationships, and/or other suitable data. For example, the data node 604 includes one or more internal databases (e.g., capable of storing machine learning model parameters, knowledge network data, real-world data, training data, or other suitable data). In some implementations, the data node 604 stores metadata associated with data lineage and provenance tracking that provides information relating to the structural and statistical properties preserved during the synthetic data generation process (e.g., the inferred entity-relationship network, a set of constraints, or representation(s) thereof).

The data simulation platform 602 can receive inputs (e.g., node datasets, prompts, or other suitable data) from one or more devices, servers, or systems. For example, the data simulation platform 602 can receive data or transmit data using the communication engine 612, which can include software components, hardware components, or a combination of both. In some implementations, the communication engine 612 includes or communicates with a data ingestion layer capable of performing pre-processing tasks, such as data format conversion or transformation. In some aspects, the communication engine 612 includes or interfaces with a network card (e.g., a wireless network card or a wired network card) that is associated with software to drive the card, thereby enabling communication with the network 650. In some implementations, the communication engine 612 also receives data from and/or communicates data with the data node 604, or another computing device associated with the network 650. The communication engine can interface with other components of the data simulation platform 602, including the graph generation engine 614, the statistical analysis engine 616, the data generation engine 618, the relationship consistency engine 620, the temporal coherence engine 622, the validation engine 624, and/or the export engine 626.

As an illustrative example, the data simulation platform 602 can receive, via the communication engine 612, a node dataset that includes information relating to entities (e.g., within a distributed system) and relationships between the entities. For example, the node dataset includes an entity dataset (e.g., describing attributes associated with particular nodes or entities of a set of nodes), as well as a relationship dataset (e.g., including a representation of relationships between various nodes of the set of nodes).

A node dataset can include information characterizing a distributed network (e.g., real-world data). The node dataset can include structured data (e.g., in the form of a knowledge network) and/or unstructured data For example, a node dataset includes an entity dataset and a relationship dataset. The entity dataset can include a representation of a set of nodes and associated node values. For example, a node represents a distinct entity within the system being modeled (e.g., a financial trade network or a distributed microservices network). A node can include a computational or logical unit within a system that includes particular attributes and can participate in relationships with other nodes. In the context of a microservices distributed system, a node can, for example, include a containerized microservice with attributes such as a service identifier, a container version, a deployment region, CPU usage, memory consumption, API endpoint configurations, and/or associated resource usage statistics. Additionally or alternatively, a node includes a trading entity (e.g., a prime broker, a customer, a hedge fund, and/or associated devices), associated with attributes such as an entity identifier, asset classes handled, daily trading volumes, risk limits, regulatory status, counterparty relationships, and/or information associated with particular transactions.

The relationship dataset can include a representation of one or more relationships within the received data. For example, a relationship includes a connection or association between two or more nodes that define, characterize, or describe how entities interact, depend on, or influence one another within the system. The relationships can be associated with attributes, semantic labels, or other characterizing data. For example, a relationship includes rules or descriptions (e.g., logs) of API calls between particular microservices, including attributes such as call frequency, response latency, data payload size, authentication methods, and/or error rates. Additionally or alternatively, a relationship includes data characterizing transaction flows between trading entities (e.g., prime brokers, hedge funds, customers, and/or associated devices), including attributes such as transaction frequency, settlement times, transaction volumes, counterparty risk scores, and/or regulatory compliance status.

In some implementations, the node dataset includes a knowledge network (e.g., representing the real-world data). A knowledge network can include a structured representation (e.g., a tabulated data structure, map, graph, vector, or another suitable structure) of entities, relationships, and associated attributes that captures the semantic meaning and/or interconnections within a domain or network. The knowledge network can provide a framework for organizing and understanding complex data relationships through nodes representing entities and edges representing relationships between the entities. For example, the knowledge network can include nodes representing individual microservices and edges representing API dependencies, data flows, and service interactions, with attributes capturing operational metrics and configurational details. Additionally or alternatively, a knowledge network includes nodes that represent trading entities (e.g., prime brokers, hedge funds, and trading desks), with edges representing the relationships, including transaction relationships, communication channels, regulatory dependencies, and/or other suitable relationships. For example, an edge of the knowledge network represents and/or are associated with attributes, such as trading volumes, risk metrics, and/or compliance requirements.

In some implementations, the data simulation platform 602 includes the graph generation engine 614. The graph generation engine 614 can perform tasks relating to generation of and/or tuning of knowledge networks (e.g., node maps or ontological maps), including entity identifiers and relationships between associated entities. The graph generation engine 614 can include hardware components, software components, or a combination of both. For example, the data simulation platform 602 can use the graph generation engine 614 to construct knowledge networks that represent structural relationships within received node datasets, such as dependencies between microservices in distributed systems or connections between financial entities in trading networks. In some implementations, the knowledge network represents explicit relationships (e.g., as defined or described within the real-world data or node dataset). Additionally or alternatively, the graph generation engine 614 (e.g., using the statistical analysis engine 616 and/or the relationship consistency engine 620) can determine latent relationships based on statistical trends, patterns, or attributes of the underlying data. For example, the graph generation engine 614 enhances existing knowledge networks by incorporating statistical information, thereby enabling identification of previously unknown dependencies or latent communication patterns between system components. The graph generation engine 614 can communicate with or interface with other components of the data simulation platform 602, including the communication engine 612, the statistical analysis engine 616, the data generation engine 618, the relationship consistency engine 620, the temporal coherence engine 622, the validation engine 624, and/or the export engine 626.

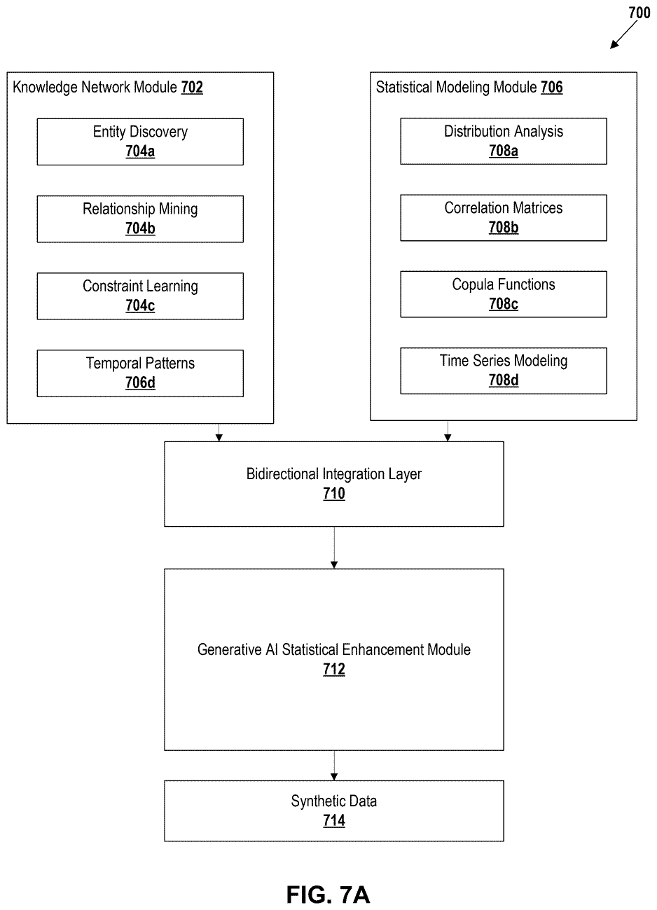

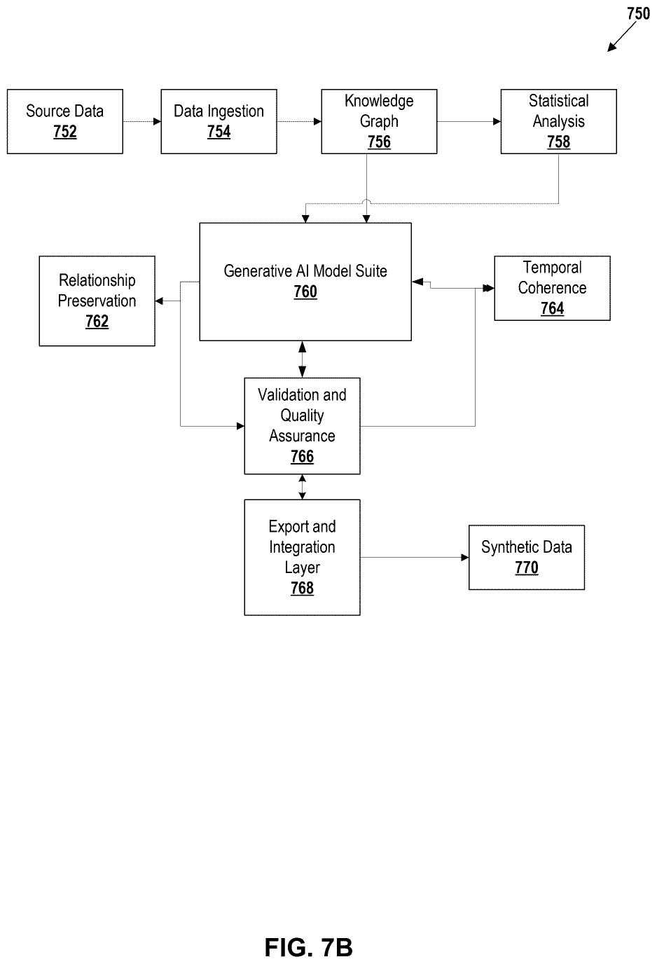

FIG. 7A illustrates an example of a data simulation platform architecture 700 that employs bidirectional integration between statistical inference and knowledge network generation, in accordance with one or more implementations of the disclosed technology. For example, the data simulation platform architecture 700 includes a knowledge network module 702, a statistical modeling module 706, a bidirectional integration layer 710, and/or a generative AI statistical enhancement module 712. Using the data simulation platform architecture 700, the data simulation platform 602 can generate synthetic data 714 that is consistent with real-world data (e.g., associated with an input node dataset, as described above).

FIG. 7B illustrates an example of a system architecture 750 for generating simulated data based on real-world data, in accordance with one or more implementations of the disclosed technology. For example, the data generation platform 602 can receive source data 752 (e.g., corresponding to a node dataset). The data generation platform 602 can perform data ingestion 754 (e.g., by pre-processing the data and/or structuring any unstructured data within the node dataset). Based on the pre-processed data, the data generation platform 602 can generate a knowledge graph (e.g., generate an entity-relationship network using the knowledge network module 702 of FIG. 7A) that is consistent with defined or implied relationships within the dataset.

As an illustrative example, the graph generation engine 614 of FIG. 6 is associated with the knowledge network module 702 and can carry out associated operations. The knowledge network module 702 can perform operations including entity discovery 704a, relationship mining 704b, constraint learning 704c, and/or can generate temporal patterns 706d.

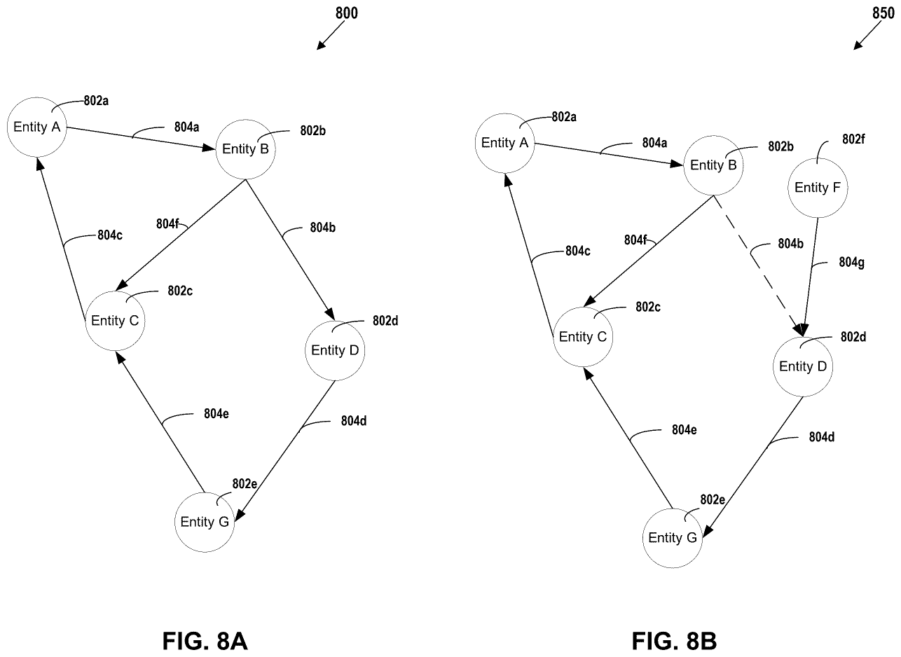

FIG. 8A illustrates a knowledge network 800 showing entity nodes and associated explicit relationships, in accordance with one or more implementations of the disclosed technology. To illustrate, the knowledge network 800 includes nodes 802a-802e, each representing a particular entity. The knowledge network 800 can include representations of relationships 804a-804e.

In some implementations, the graph generation engine 614 generates a knowledge network based on explicit relationships and attributes (e.g., entities) represented within the associated input node dataset (e.g., the real-world data). For example, the graph generation engine 614 can discover different entities and/or restructure unstructured data associated with the input node dataset to determine entity types associated with entities of the node dataset. The entity types include categories of objects within the data (e.g., microservice types and/or financial entity types, such as customer, products, and/or transactions). For example, the entity type can include an indication that a particular node is a customer, transaction, product or location. Additionally or alternatively, the entity represented within the knowledge network can include identity-based, transactional, categorical, locational, temporal, sensitive, and/or derived attributes. Attributes associated with customer-type entities can include identifiers, names, ages, and other suitable attributes. Attributes associated with transaction-type entities can include identifiers, dates, amounts, or other suitable attributes. Attributes associated with location-type entities can include identifiers, addresses, regions, or other suitable attributes. Attributes associated with product-type entities can include identifiers, names, categories, and other suitable attributes. In some implementations the knowledge networks (e.g., including associated entities or entity attributes) can be updated based on statistical or temporal inferences, as described below.

In some implementations, the knowledge network includes edges (e.g., the relationships 804a-804e) that represent connections between entities with associated constraints and cardinalities. For example, the knowledge network module 702 can execute relationship mining 704b operations to generate structured data representing relationships within the real-world data (e.g., the node dataset). In some implementations, the relationships can include identifiers of nodes associated with the endpoints of the relationship. For example, the relationship 804b can be associated with a node identifier for the node 802b (e.g., a source endpoint) and the node 802d (e.g., a target endpoint). The relationship can be associated with one or more types (e.g., and associated labels). Relationship types can include association, temporal, hierarchical, dependency, and/or causal relationships.

Moreover, referring to FIG. 6, the data simulation platform 602 can include the statistical analysis engine 616. The statistical analysis engine 616 enables extraction and analysis of statistical information, metrics, and patterns from node datasets and knowledge networks. The statistical analysis engine 616 can include software components, hardware components, or a combination of both. For example, the statistical analysis engine 616 analyzes relationships, values, and attributes of node datasets (e.g., datasets associated with microservice usage within a distributed network or transactions within a financial network). Based on the analysis, the statistical analysis engine 616 can infer statistics, such as correlation coefficients, distribution parameters, variance values, and other statistical metrics that characterize interdependencies between entities or nodes. In some implementations, the statistical analysis engine 616 includes or interfaces with specialized processing units (e.g., graphics processing units or tensor processing units) that are associated with software to drive the units, thereby enabling efficient, paralell statistical computation and pattern recognition. The statistical analysis engine 616 can perform univariate analysis, multivariate correlation analysis, conditional dependency analysis, outlier detection, and time-series statistical analysis (e.g., independently or in conjunction with the temporal coherence engine 622). The statistical analysis engine 616 can communicate with or interface with other components of the data simulation platform 602, including the communication engine 612, the graph generation engine 614, the data generation engine 618, the relationship consistency engine 620, the temporal coherence engine 622, the validation engine 624, and/or the export engine 626.

The statistical analysis engine 616 enables performance of statistical analysis 758 of FIG. 7B (e.g., based on statistical distribution modeling). As an illustrative example, the statistical analysis engine 616 can drive the statistical modeling module 706 (e.g., including one or more statistical inference models) of the data simulation platform architecture 700. The statistical modeling module 706 can perform operations including distribution analysis 708a, generation of correlation matrices 708b, generation and evaluation of copula functions 708c, and/or time-series modeling 708d. For example, the data simulation platform 602 provides the node dataset to a statistical inference model (e.g., associated with the statistical modeling module 706) to generate an inferred statistical dataset for the node dataset, including one or more copulae characterizing the dependence between random variables within the node dataset. Additionally or alternatively, the data simulation platform 602 provides a knowledge network representing the node dataset to the statistical inference model to generate the inferred statistical dataset. The statistical modeling model associated with the module can include one or more artificial intelligence models, as described with respect to FIG. 4.

To illustrate, inferred statistical dataset can include statistical metrics and associated values, where the statistical metrics are associated with nodes of the node dataset and/or associated relationships. For example, the data simulation platform 602 performs a correlation analysis, including identifying statistical correlations between API call latencies of different microservices in a distributed system or determining correlation coefficients between trading volumes of interconnected financial entities. Additionally or alternatively, the data simulation platform 602 performs causal discovery, including applying Granger causality tests to identify temporal dependencies between microservice performance metrics or discovering causal relationships between trading decisions of different entities within a distributed financial network. Additionally or alternatively, the data simulation platform 602 performs cluster detection, including identifying groups of microservices with similar resource usage patterns or detecting trading communities within financial networks based on transaction behaviors. Additionally or alternatively, the data simulation platform 602 detects and determines anomaly patterns, including identifying unusual API call flows between microservices that indicate system issues, or detecting atypical trading patterns that represent market opportunities or risk indicators.

For example, statistical metrics that are monitored include univariate metrics, such as mean, variance, and distribution parameters for individual node attributes; multivariate metrics, such as correlation coefficients and covariance matrices between different entities; conditional dependency metrics capturing how values of one attribute affect distributions of others; outlier characteristic metrics identifying anomalous patterns and their frequencies; and time-series patterns that capture seasonal variations, trends, cyclical patterns, autocorrelation measures, temporal cross-correlation measures, and other suitable temporal dependencies. For example, statistical metrics include average API call latencies, distribution of service dependencies, correlation patterns between resource usage across different microservices, and/or temporal patterns in system load. Additionally or alternatively, statistical metrics include transaction volume distributions, correlation coefficients between trading entities, risk correlation patterns, volatility measures, and/or temporal trading frequency patterns capturing market dynamics and behavioral relationships.

Based on the inferred statistical dataset generated at the statistical inference model, the data simulation platform can generate, update, and/or tune a knowledge network representing the real-world data (e.g., using a generative AI model suite 760 of FIG. 7B). For example, using the knowledge network module 702 and the bidirectional integration layer 710, the data simulation platform 602 generates an inferred entity-relationship network that includes inferred node identifiers and node relationships based on the structural, semantic, and statistical properties of the node dataset (e.g., as described within the inferred statistical dataset). In some implementations, the statistical analysis engine 6016 uses the generative AI statistical enhancement module 712 and/or the generative AI model suite 760 to generate the inferred entity-relationship network (and/or tune the knowledge network).

FIG. 8B illustrates an inferred entity-relationship network 850 including modifications to the knowledge network of FIG. 8A, in accordance with one or more implementations of the disclosed technology. For example, the inferred entity-relationship network includes modified or generated relationships, constraints, and/or other information based on statistical or relationship-based analysis of the real-world data (e.g., the received node dataset). For example, the inferred entity-relationship network 850 includes an additional relationship 804g and an additional node (e.g., the node 802f) as compared to the knowledge network 800 of FIG. 8A (e.g., based on an inference of a correlation between the node 802f and the node 802d that was not included in the original node dataset and/or knowledge network). In some implementations, the inferred entity-relationship network does not include a relationship (e.g., the relationship 804b) or a node of the original knowledge network (e.g., if an explicit correlation is not statistically significant), thereby enabling the system to detect and adapt changes in relationships or communications between different entities.

In some implementations, the knowledge network (inferred or original) can incorporate constraints, such as domain-specific constraints and/or validation rules. For example, the inferred entity-relationship network includes regulatory compliance constraints ensuring that synthetic financial data adheres to Basel III capital requirements, MiFID Il transaction reporting standards, or anti-money laundering detection rules. Additionally or alternatively, the inferred entity-relationship network includes architectural constraints (e.g., associated with a distributed microservice system) that includes service dependency hierarchies, API versioning compatibility rules, resource allocation limits, and/or security access control policies. In some implementations, the inferred entity-relationship network incorporates business logic constraints (e.g., referential integrity requirements between customers and transaction entities, temporal ordering constraints for sequential market events, cardinality restrictions that limit the number of relationships between specific entity types, and statistical boundary conditions that ensure that synthetic data maintains realistic value ranges and distribution properties consistent with the underlying real-world system.

In some implementations, the data simulation platform 602 includes the relationship consistency engine 620 (e.g., a relationship preservation framework to enable relationship preservation 762 of FIG. 7B). The relationship consistency engine 620 enables preservation and validation of complex inter-entity relationships prior to, during, and/or after synthetic data generation, enabling the preservation of direct and indirect dependencies. The relationship consistency engine 620 can include software components, hardware components, or a combination of both. For example, the relationship consistency engine 620 employs constraint satisfaction algorithms, relationship-aware sampling techniques, and post-generation validation to ensure that synthetic data adheres to structural integrity requirements and business logic constraints. In some implementations, the relationship consistency engine 620 interfaces with or includes specialized processing units (e.g., graph processing units or parallel computing clusters) that are associated with software to drive the units, thereby enabling efficient relationship validation and constraint checking. In some implementations, the relationship consistency engine 620 generates relationship embeddings, performs topological analysis of entity dependencies, and implements corrective feedback loops (e.g., via the validation engine 624) to address relationship violations during or following the generation process. The relationship consistency engine 620 can communicate with or interface with other components of the data simulation platform 602, including the communication engine 612, the graph generation engine 614, the statistical analysis engine 616, the data generation engine 618, the temporal coherence engine 622, the validation engine 624, and/or the export engine 626.

As an illustrative example, the data simulation platform 602 can generate a set of constraints (e.g., based on the statistical dataset inferred from the real-world data and/or using the knowledge network module 702 to perform constraint learning 704c) for generation of simulated data using the inferred entity-relationship network and/or the inferred statistical dataset. The set of constraints can include indications of relationships (e.g., within the inferred entity-relationship network) to be constrained or set and/or can include other policies to guide or limit the generation of synthetic data, thereby improving its real-world applicability. For example, the set of constraints includes structural integrity constraints that preserve valid entity relationships and hierarchical dependencies. Additionally or alternatively, the set of constraints can include statistical fidelity constraints that maintain correlation patterns and distribution properties observed in the original data. In some aspects, the set of constraints includes temporal coherence constraints that ensure sequencing of events and causal relationships analogous to those in real-world data (e.g., the received node dataset). Additionally or alternatively, the set of constraints includes regulatory compliance constraints that enforce industry-specific rules (e.g., capital adequacy ratios or data protection requirements) and/or cardinality constraints (e.g., limiting the number of permissible relationships between entity types. In some implementations, the inferred entity-relationship network includes the set of constraints. Additionally or alternatively, the data simulation platform 602 generates the set of constraints based on or independently of the inferred entity-relationship network. To illustrate, the bidirectional integration layer 710 can control the degree to which the inferred entity-relationship network is influenced by statistical inferences (e.g., by the statistical modeling module 706).

In some implementations, the data simulation platform 602 can generate the set of constraints including hierarchical and/or priority-based handling. For example, the data simulation platform 602 organizes constraints into multiple priority levels. For example, Level 1 critical constraints can include referential integrity requirements that are not to be violated during synthetic data generation. Level 2 important constraints can include business logic rules that define valid data states. Level 3 preferential constraints can include statistical relationship constraints that maintain data realism. Level 4 optimization constraints can include performance and distribution constraints. The data simulation platform 602 can dynamically adjust constraint prioritization based on computational resource availability, regulatory requirements, or specific use-case demands, thereby enabling that higher-priority constraints are satisfied while lower-priority constraints are applied when system resources permit. For example, critical constraints can include regulatory capital limits and settlement requirements, while preferential constraints can include maintaining historical trading volume correlations and market microstructure patterns. As an illustrative example, the data simulation platform 602 determines a priority threshold level based on a computational resource usage level associated with the data simulation platform 602. For example, the priority threshold level is relatively high (e.g, a given constraint requires a relatively high priority for inclusion within the set of constraints and/or for incorporation within the simulated node dataset or generated synthetic data) when the computational resource usage of the system is relatively high. Additionally or alternatively, the data simulation platform 602 determines a relatively low priority threshold level (e.g., where any constraints of any priority level can be incorporated within the simulated node dataset or generated synthetic data) when the computational resource usage is relatively low. For example, the priority threshold level is proportional to a resource usage metric value associated with the computing system.

In some implementations, the data simulation platform 602 uses relationship-preserving sampling to generate indications of constraints (e.g., statistical constraints). For example, the data simulation platform 602 (e.g., via the statistical modeling module 706 and/or the bidirectional integration layer 710) employs Gibbs sampling with constraints to iteratively sample values while respecting entity relationships. The data simulation platform 602 can use a Metropolis-Hastings algorithm with relationship potential functions to accept or reject samples based on relationship consistency. The data simulation platform 602 can use variational inference techniques to approximate complex joint distributions while maintaining interdependencies between nodes (e.g., entities). The relationship-preserving sampling can generate constraint indicators that specify acceptable value ranges for correlated attributes, maintain conditional probability distributions between related entities, preserve temporal ordering requirements for sequential data, and enable synthetic data generation that adheres to explicit relationships defined in the original knowledge network and implicit statistical dependencies discovered through the bidirectional integration process between structural relationships within the knowledge network and the statistically-inferred relationships associated with the underlying real-world data.

In some implementations, the data simulation platform 602 generates the constraints including embeddings of relationships. For example, the data simulation platform 602 creates learned vector representations of relationships using graph neural network embeddings that capture complex relationship patterns (e.g., multi-hop relationships), relationship type embeddings that encode different semantic categories of connections between entities, contextual relationship embeddings (e.g., that adapt based on specific entities being connected and their attributes) and temporal relationship embeddings (e.g., that capture time-varying relationship dynamics over time). To illustrate, the data simulation platform 602 can ensure temporal coherence 764 (e.g., shown in FIG. 7B) based on generating the temporal relationship embeddings using a temporal coherence engine. The associated relationship and temporal relationship embeddings can be incorporated into the constraint generation process to enable generation of synthetic data that preserves complex and/or nuanced relationships that are difficult to express through traditional rule-based constraints, thereby enabling the system to maintain subtle interdependencies (e.g., hierarchical trading relationships in financial networks or complex service dependencies in distributed microservices architectures) during generation of synthetic data for validation (e.g., validation and quality assurance 766 of FIG. 7B) or testing. The relationships generated or tuned using the relationship transfer learning can be incorporated within the inferred entity-relationship network and/or the set of constraints.

In some implementations, the data simulation platform 602 (e.g., through constraint learning 704c of the knowledge network module 702 of FIG. 7A) can execute relationship transfer learning to improve the accuracy and applicability of learned relationships (e.g., and associated constraints). For example, the data simulation platform 602 performs cross-domain relationship mapping to transfer relationship patterns between similar domains (e.g., applying trading network structures learned from equity markets to derivative markets). Additionally or alternatively, the data simulation platform 602 performs few-shot relationship learning to quickly adapt to new relationship types from minimal training examples. The data simulation platform 602 can leverage relationship interpolation to generate intermediate relationship states that bridge different entity types or temporal periods. Additionally or alternatively, the data simulation platform 602 performs relationship extrapolation to extend known relationship patterns to new contexts or previously unseen entity combinations. The relationship transfer learning process can leverage pre-trained relationship embeddings from large-scale knowledge networks and adapt relationship constraints based on domain-specific characteristics, thereby enabling the data simulation platform 602 to generate synthetic data that maintains relationship fidelity, even with limited training data or novel entity configurations in complex distributed systems. The relationships generated or tuned using the relationship transfer learning can be incorporated within the inferred entity-relationship network and/or the set of constraints.

In some implementations, the data simulation platform 602 (e.g., via the statistical analysis engine 616, graph generation engine 614, data generation engine 618, or the relationship consistency engine 620) can perform operations described herein in a parallel architecture to improve the performance of the data simulation platform. For example, the data simulation platform 602 enables independent subgraph generation (e.g., via the graph generation engine 614) to enable parallelization of generation of disconnected components of the inferred entity-relationship network. Additionally or alternatively, the data simulation platform 602 can generate multiple relationship options in parallel prior to selecting one to include within the inferred entity-relationship network and/or set of constraints (e.g., via a speculative relationship generation engine). By doing so, the data simulation platform 602 enables dynamic testing of various network topologies in a scalable manner. In some implementations, the data simulation platform 602 enables graphics processing unit-accelerated constraint checking via parallelization schemes to improve the performance of constraint generation and validation. Additionally or alternatively, the data simulation platform 602 enables distributed relationship validation (e.g., by scaling validation across multiple nodes), thereby reducing the computational burden of validating each node independently.

In some implementations, the data simulation platform 602 enables caching and memorization to improve the latency and performance of generation of synthetic data. For example, in some implementations, the data simulation platform 602 leverages a relationship pattern cache to store successful relationship generation patterns, thereby enabling retrieval when similar relationships arise in subsequently received real-world data. In some implementations, the data simulation platform 602 can leverage a constraint resolution cache to store solutions to common constraint problems (e.g., solutions to multi-variate or multi-entity constraints that otherwise require iterative methods for generating consistent attribute values within the inferred entity-relationship network or resulting simulated node dataset). In some implementations, the data simulation platform 602 includes a validation result cache to store validation results for repeated patterns to reduce the computational burden associated with validation tasks (e.g., with respect to the validation engine 624). In some implementations, the data simulation platform 602 includes a relationship embedding cache, enabling pre-computation and storage of relationship embeddings.

Referring to FIG. 6, in some implementations, the data simulation platform 602 includes the data generation engine 618. The data generation engine 618 enables generation of synthetic data (e.g., a simulated node dataset using the export and integration layer 768 of FIG. 7B) that maintains statistical properties, structural relationships, and/or temporal patterns of original datasets while ensuring privacy and anonymization. The data generation engine 618 can include software components, hardware components, or a combination of both. For example, the data generation engine 618 employs multiple specialized generative models, such as generative adversarial networks (GANs), variational autoencoders (VAEs), diffusion models, and transformer-based models, coordinate through a unified framework to generate high-fidelity synthetic data. In some implementations, the data generation engine 618 includes or interfaces with machine learning accelerators (e.g., graphics processing units, tensor processing units, or neural processing units) that are associated with software to drive the units, thereby enabling efficient synthetic data generation. In some implementations, the data generation engine 618 generates synthetic data based on constraints derived from inferred entity-relationship networks, ensuring that the generated data maintains both explicit structural relationships and implicit statistical dependencies. The data generation engine 618 can communicate with or interface with other components of the data simulation platform 602, including the communication engine 612, the graph generation engine 614, the statistical analysis engine 616, the relationship consistency engine 620, the temporal coherence engine 622, the validation engine 624, and/or the export engine 626.

For example, the data generation engine 618 generates a simulated node dataset (e.g., the synthetic data 770 of FIG. 7B) that can reflect and/or include synthetic entities, synthetic relationships, synthetic relationships, and/or synthetic temporal sequences. For example, synthetic entities include artificially generated data objects representing distinct elements within the system (e.g., nodes) while maintaining statistical and structural properties of real-world entities. Synthetic entities can include simulated trading desks, hedge funds, prime brokers, or individual traders with realistic attributes (e.g., trading volumes, risk tolerances, and regulatory classifications). Additionally or alternatively, synthetic entities can include containerized services, API endpoints, or computing resources with appropriate resource utilization patterns, latency characteristics, and dependency requirements that mirror production environments without exposing sensitive operational data.

Synthetic relationships (e.g., inferred relationships) can include artificially generated connections between entities that preserve the structural integrity, statistical correlations, and semantic meaning (e.g., as found in real-world data associated with the received node dataset). For example, the relationships can include transaction flows between trading entities (e.g., with realistic volumes and frequencies), counterparty risk exposures, hierarchical reporting structures between trading desks and parent institutions, or market correlation patterns between different asset classes. In some implementations, the data simulation platform 602 generates synthetic relationships within the simulated node dataset that include API call dependencies between simulated services, simulated data flow patterns, authentication requirements, service-level agreements, and resource-allocation relationships that maintain the complex interdependencies of the original system while enabling testing without operational leakage or risk.

In some implementations, the data simulation platform 602 includes the temporal coherence engine 622. The temporal coherence engine 622 enables preservation of time-based patterns, sequential relationships, and causal dependencies in synthetic data generation, enabling preservation of the logical progression of events and the maintenance of temporal integrity. The temporal coherence engine 622 can include software components, hardware components, or a combination of both. For example, the temporal coherence engine 622 employs multiscale attention mechanisms, hierarchical encodings, neural Hawkes processes, and temporal point processes to model sequences and generate temporal dependency graphs that capture static and dynamic interrelationships. In some aspects, the temporal coherence engine 622 includes or interfaces with time-series processing units or recurrent neural network accelerators that are associated with software to drive the units, thereby enabling efficient temporal pattern analysis and sequence modelling (e.g., in a parallelizable manner). In some implementations, the temporal coherence engine 622 preserves seasonal patterns, cyclical behaviors, and causal sequences while maintaining static and dynamic statistical distributions, thereby enabling synthetic data to reflect realistic time-based behaviors essential for applications requiring temporal fidelity. The temporal coherence engine 622 can communicate with or interface with other components of the data simulation platform 602, including the communication engine 612, the graph generation engine 614, the statistical analysis engine 616, the data generation engine 618, the relationship consistency engine 620, the validation engine 624, and/or the export engine 626.

As such, the data simulation platform 602 can generate the synthetic data (e.g., the simulated node dataset) including and/or adhering to synthetic temporal sequences. Synthetic temporal sequences can include artificially generated time-series data that preserves chronological patterns, seasonal variations, and causal relationships present in the real-world temporal data (e.g., as associated with the received node dataset). For example, the sequences include trading activity patterns showing realistic market open/close effects, seasonal volatility cycles, reaction sequences to market events, settlement timelines for different transaction types, or regulatory reporting schedules (e.g., with appropriate temporal dependencies). The synthetic temporal sequences can include traffic pattern variations throughout the day within a distributed microservices platform, service deployment and scaling events, scheduled maintenance windows, cascading failure patterns, and/or recovery sequences that maintain the temporal coherence necessary for realistic system testing and optimization.

For example, the temporal coherence engine 622 enables generation of temporal dependency graphs (e.g., using dynamic graph neural networks, causal discovery, dependency strength evaluations, and edge classification (e.g., classification of a particular relationship as being temporal, causal, or correlated in nature). The temporal coherence engine 622 can include domain-specific modules. For example, in the context of a complex financial entity network, the temporal coherence engine includes a transaction sequencer (e.g., enabling sequence analysis of different transactions, subject to settlement dependencies and regulatory constraints), a market-event correlator (e.g., correlating market events with cross-asset cascades or volatility spillover), a regulatory sequencer (e.g., enabling encoding of reporting deadlines and/or compliance patterns), and/or an anomaly preserver (e.g., enabling preservation of fraud patterns and/or market shocks). In some implementations, the data simulation platform 602, via the temporal coherence engine 622, evaluates the temporal fidelity of generated synthetic data and/or associated inferred entity-relationship networks or temporal dependency graphs based on autocorrelation similarity, event timing accuracy, a causal preservation score, and/or a sequence likelihood. In some implementations, the data simulation platform 602 enables adaptive temporal resolution (e.g., changing the time-step value associated with a time-series dynamically), temporal indexing, parallel processing, and/or graphics processing unit acceleration.

As an illustrative example, the data simulation platform 602 incorporates time-series data associated with the node dataset to enhance temporal modeling capabilities. Each data point of the time-series data can be associated with a particular timestamp, enabling the system to capture temporal dependencies and sequential relationships. The data simulation platform 602 can provide the time-series data along with other components (e.g., the node dataset, inferred entity-relationship network, set of constraints, or inferred statistical dataset) to a temporal coherence model to generate a temporal dependency graph that identifies temporal dependency constraints, sequence progression constraints, or time-based correlations. For example, the temporal dependency graph can capture the sequential nature of market events, such as how order placements during market volatility periods influence subsequent trading patterns across interconnected trading desks. The temporal coherence model enables the data simulation platform 602 to generate synthetic datasets that preserve realistic time-dependent behaviors and causal relationships, thereby improving the accuracy of synthetic data for training machine learning models in algorithmic trading systems or risk assessment applications.

Synthetic anomalies can include artificially generated edge cases, outliers, or unusual patterns that maintain the statistical and contextual characteristics of anomalies found in real-world data. For example, an anomaly includes unusual trading patterns indicative of market manipulation, liquidity gaps during stress events, flash crash scenarios, compliance violations, or fraud indicators with appropriate statistical rarity and contextual relationships. In some implementations, synthetic anomalies include simulated service degradation patterns, resource exhaustion scenarios, unusual traffic spikes, security breach indicators, or cascading failure conditions that enable testing of detection and mitigation systems without introducing actual vulnerabilities or disruption to the real-world system.

In some implementations, the data simulation platform 602 includes an anomaly preservation framework to enable generation of synthetic anomalies. For example, the data simulation platform 602 detects anomalies at multiple levels (e.g., based on statistics, pattern recognition, and/or the associated domain). In some implementations, the data simulation platform 602 classifies detected anomalies by value (e.g., with respect to alpha generation, market intelligence, risk indicators, and/or strategic signals). In some implementations, the data simulation platform 602 enables preservation of particular temporal relationships (e.g., based on a financial impact score, strategic value score, and/or relationship preservation rules).

In some implementations, the data simulation platform 602 can perform multi-dimensional bias mitigation for the synthetic data (e.g., the simulated node dataset) and associated inferred entity-relationship network and/or constraints. For example, the data simulation platform 602 enables mitigation of direct discrimination bias, indirect/proxy discrimination bias, historical bias, representation bias, aggregation bias, and/or confirmation bias.

The data simulation platform 602 can receive bias-related input data, including financial transactions, associated demographics, credit histories, and/or market data. The data simulation platform 602 can utilize the statistical modeling module 706 to conduct demographic parity testing and/or conditional statistical tests to generate distribution divergence metrics, thereby enabling an intersectional analysis of various factors associated with bias. The data simulation platform 602 can leverage a causal analysis module to perform counterfactual reasoning, explore path-specific effects, conduct a mediation analysis, and/or detect confounding factors. In some implementations, the data simulation platform 602 includes a fairness module that leverages adversarial debiasing networks, fair representation learning, bias amplification detection, and/or model interpretability analyses. By doing so, the data simulation platform 602 can perform multi-metric aggregation to determine a confidence score associated with bias detection within a particular dataset (e.g., received and/or generated). In some implementations, the data simulation platform 602 detects a particular type of bias and assigns a severity level to the detected biases. Additionally or alternatively, the data simulation platform 602 can provide the bias-related information to a regulatory compliance verification module to determine whether the generated synthetic data (e.g., the associated simulated node dataset) complies with regulatory requirements. Based on the determination, the data simulation platform 602 can generate a bias detection report to enable mitigation of bias within the data simulation platform 602.

The data simulation platform 602 (e.g., via the data generation engine 618) can generate the simulated node dataset (e.g., suitable synthetic data) in a relationship-aware manner (e.g., by performing a relationship topology analysis, by leveraging contextual generation windows, or by leveraging the relationship-preserving sampling discussed above).

To illustrate, the data simulation platform 602 can perform a relationship topology analysis to generate simulated data associated with strongly connected components together. The data simulation platform 602 can determine, within the inferred entity-relationship network, at least two inferred nodes of the set of inferred nodes that are associated with a first inferred relationship of the set of inferred node relationships. In response, the data simulation platform 602 can determine a topological sort of portions of the inferred entity-relationship network to determine an order in which to generate the simulated node dataset (e.g., the synthetic data). For example, a topological sort includes an ordering of nodes in a directed graph such that, for every directed edge from node A to node B, node A appears before node B in the ordering. As an illustrative example, the data simulation platform 602 processes prime brokers (e.g., with no dependencies), then hedge funds (e.g., which depend on prime brokers), and finally individual trading desks (e.g., which depend on both prime brokers and hedge funds). Additionally or alternatively, the platform can process core services first, followed by dependent middleware services, and finally user-facing applications that rely on both core and middleware components. The approach enables the generation of dependent entities in a manner that maintains the accuracy and business logic of network relationships, while enabling efficient parallelization of generation of synthetic data. In some implementations, the data simulation platform 602 can detect and resolve circular dependencies through relationship relaxation (e.g., by removing or relaxing a particular constraint).

In some implementations, the data simulation platform 602 generates the simulated dataset while maintaining a sliding context window. By doing so, the data simulation platform 602 (e.g., via the data generation engine 618) can preserve local relationship contexts and dependencies while limiting the burden on computational resources. Contextual generation windows can define bounded regions (e.g., within the inferred entity-relationship network) where entities and associated relationships are generated together as cohesive units, thereby ensuring that the synthetic data maintains contextual integrity of interrelated components. To enable harmonization between portions of the simulated dataset that are generated asynchronously, the context can include backward context (e.g., previously generated entities that constrain current generation), forward context (e.g., placeholder constraints for entities yet to be generated), lateral context (e.g., information relating to peer entities at the same hierarchical level) and/or temporal context (e.g., associated with time-based relationships and sequences). For example, a context generation window can include a prime broker and its directly connected hedge funds, ensuring that synthetic trading volumes, risk exposures, and transaction patterns between the entities remain consistent with the observed relationships in the original data. The data simulation platform 602 can dynamically adjust the size and scope of the contextual windows based on the density of relationships, computational resources, and specific requirements of the target application, thereby enabling generation of synthetic data that preserves local relationship fidelity and global network coherence.

In some aspects, different components of the simulated node dataset (e.g., the synthetic data) are generated using a variety of specialized generative models. For example, the data generation engine 618 includes models, such as graph neural networks, variational autoencoders, transformer-based models, generative adversarial networks, and/or diffusion models. Each specialized generative model of the model suite can be associated with a particular model specialization that enables targeted generation of specific data types or patterns within the simulated node dataset. To illustrate, graph neural networks can specialize in generating entity relationships and network structures, preserving hierarchical dependencies and complex interconnections between nodes such as trading relationships in financial networks or service dependencies in distributed systems. Variational autoencoders can focus on generating statistical distributions and maintaining probabilistic relationships between attributes associated with nodes or relationships, ensuring that synthetic data preserves the underlying statistical properties (e.g., associated with transaction volumes, risk metrics, or resource utilization patterns). Transformer-based models can specialize in sequence data generation (e.g., to create temporal patterns and time-series information that capture market dynamics, trading frequencies, or system performance metrics over time). Generative adversarial networks can include high-fidelity instance generation, including realistic generation of synthetic entities with complex attribute combinations mirroring real-world trading desks, financial instruments, or system components. Diffusion models can specialize in numerical data generation, enabling generation of continuous-valued attributes (e.g., transaction amounts, latency measurements, or risk scores), while maintaining appropriate distributions and correlations. The data simulation platform 602 can generate portions of the simulated node dataset where each portion is processed by the corresponding specialized model to generate model outputs that are subsequently integrated into the comprehensive simulated node dataset.

In some implementations, the data simulation platform 602 includes the validation engine 624. The validation engine 624 can enable verification of synthetic data quality (e.g., to determine whether the generated data meets specified criteria for statistical fidelity, structural integrity, privacy preservation, and/or regulatory compliance). The validation engine 624 can include software components, hardware components, or a combination of both. For example, the validation engine 624 performs structural validation through graph isomorphism testing, cardinality verification, referential integrity checking, and/or constraint satisfaction verification processes. For example, the validation engine 624 can perform statistical validation testing (e.g., by comparing distributions and correlations), as well as semantic validation (e.g., via business rule verification or contextual coherence testing). In some aspects, the validation engine 624 includes or interfaces with validation accelerators or distributed computing resources that are associated with software to drive the units, thereby enabling efficient, large-scale validation and quality assurance processes. In some implementations, the validation engine 624 generates validation reports, calculates quality metrics, performs privacy leakage analyses, and provides feedback to other engines for iterative improvement of synthetic data generation (e.g., via a feedback mechanism). The validation engine 624 can communicate with or interface with other components of the data simulation platform data simulation platform 602, including the communication engine 612, the graph generation engine 614, the statistical analysis engine 616, the data generation engine 618, the relationship consistency engine 620, the temporal coherence engine 622, and/or the export engine 626.

For example, the data simulation platform 602 can determine, using the validation engine 624, a validation status for components or aspects of the synthetic data (e.g., the simulated node dataset). The validation engine 624 can input the simulated node dataset into a validation model to generate a validation report for the simulated node dataset. The validation report can include an indication of at least one of a structural validation status, a statistical validation status, or a semantic validation status.

The structural validation status can include an indication of whether the simulated node dataset is consistent with the inferred entity-relationship network and the set of constraints. For example, the structural validation status includes an indication of whether synthetic trading relationships maintain proper hierarchical dependencies (e.g., between prime brokers and hedge funds, as defined in the inferred entity-relationship network). To illustrate, the validation engine 624 performs graph isomorphism testing to verify that the relationship structure matches the original (e.g., real-world) data. The validation engine 624 can perform cardinality verification to ensure that relationship multiplicities are preserved. Additionally or alternatively, the validation engine 624 performs referential integrity checking to validate foreign key relationships. The validation engine 624 can perform constraint satisfaction verification to determine whether the simulated node dataset satisfies defined constraints (e.g., within the set of constraints).

The statistical validation status can include an indication of whether the simulated node dataset is consistent with the inferred statistical dataset. To illustrate, the statistical validation status can include an indication of whether synthetic transaction volumes preserve correlation patterns and distribution properties observed in the original, real-world data. For example, the data simulation platform 602 (e.g., via the validation engine 624) can perform joint distribution testing to validate the existence of relationship-dependent distributions (e.g., as consistent with the real-world data). The data simulation platform 602 can compare correlation matrices (e.g., via the correlation matrices 708b operation of the statistical modeling module 706) to determine that the correlation matrices (e.g., between different attributes of the inferred entity-relationship network or resulting simulated node dataset) are similar to the correlation matrices observed in the real-world data (e.g., in the received node dataset). Additionally or alternatively, the data simulation platform 602 can verify conditional probability relationships (e.g., using Bayes' theorem). The data simulation platform 602 can perform mutual information analysis (e.g., to validate information content between related entities.

The semantic validation status can include an indication of whether the simulated node dataset is consistent with rule-based constraints. To illustrate, the semantic validation status includes an indication of whether the generated synthetic data (e.g., the simulated node dataset) adheres to business logic constraints, such as regulatory capital requirements or trading limit restrictions (e.g., in a domain-specific manner). For example, the data simulation platform 602 performs temporal consistency checking (e.g., to validate time-based relationship logic). The data simulation platform 602 can verify transitive relationships (e.g., to ensure that indirect relationships are preserved). Additionally or alternatively, the data simulation platform 602 performs contextual coherence testing (e.g., to validate that generated relationships make semantic sense).

Based on the validation report, the data simulation platform 602 can input the simulated node dataset into a data generation model to generate an updated simulated node dataset (e.g., that is consistent with the inferred entity-relationship network and is based on the simulated node dataset and the validation report). For example, the data simulation platform 602, via the validation engine 624, employs one or more feedback loops to improve the accuracy of generated synthetic data.

In some implementations, the data simulation platform 602 implements a multi-level feedback architecture. For example, data simulation platform 602 implements micro-feedback mechanisms that enable entity-level corrections with fast response times (e.g., along the order of 1 ms), enabling real-time adjustments to individual synthetic trading entities or microservices. The data simulation platform 602 can implement meso-feedback mechanisms for batch-level adjustments (e.g., with response times of approximately 100 ms), enabling corrections to groups of related financial instrument or service clusters, for example. The data simulation platform 602 can implement macro-feedback mechanisms for system-wide tuning (e.g., with response times of approximately 1 s), thereby enabling holistic adjustments to market-wide or system-wide patterns. In some implementations, the data simulation platform 602 implements meta-feedback mechanisms (e.g., that optimize the feedback process itself) by dynamically adjusting correction parameters (e.g., based on historical effectiveness).

In some implementations, the data simulation platform 602 implements adaptive correction strategies. For example, the data simulation platform 602 implements gradient-based correction strategies that use relationship violation gradients to incrementally adjust synthetic data parameters toward target statistical distributions. In some implementations, the data simulation platform 602 uses reinforcement learning correction strategies (e.g., that use reward signals based on statistical fidelity and relationship preservation) to guide synthetic data generation, thereby improving the synthetic data's accuracy and compliance with associated requirements. The data simulation platform 602 can implement evolutionary correction strategies that generate multiple candidate synthetic datasets and select those with superior preservation of inferred relationships (e.g., “critical”-level financial relationships/constraints or service dependencies). In some implementations, the data simulation platform 602 performs Bayesian optimization correction strategies that build probabilistic models associated with generation parameters (e.g., associated with the inferred entity-relationship network), thereby enabling efficient exploration of the parameter space for improved generation of simulated data.

In some implementations, the data simulation platform 602 implements feedback propagation mechanisms. For example, the data simulation platform 602 implements backward propagation mechanisms that adjust upstream generation parameters (e.g., associated with various generation models of the generation model suite) based on current quality assessments. The data simulation platform 602 can implement forward-propagation correction mechanisms that proactively adjust future synthetic data generation, thereby enabling anticipatory corrections to the generation pipeline. The data simulation platform 602 can implement lateral propagation mechanisms for feedback (e.g., to improve generation of synthetic data, such as the simulated node dataset) by coordinating adjustments across peer entities (e.g., by spreading corrections to other entities at the same hierarchical level within the inferred entity-relationship network). The data simulation platform 602 can implement temporal propagation mechanisms (e.g., by adjusting time-based dependencies to maintain consistency across time-based relationships, thereby preserving seasonal patterns in market activity).

In some implementations, the data simulation platform 602 includes the export engine 626. The export engine export engine 626 enables conversion, formatting, and transmission of synthetic data to target systems, applications, or devices in formats compatible with their requirements and use cases. The export engine 626 can include software components, hardware components, or a combination of both. For example, the export engine 626 converts synthetic data into structured datasets for database testing, API call logs for performance analysis, streaming data for real-time system validation, or specialized formats for machine learning model training and artificial intelligence applications. In some aspects, the export engine 626 includes or interfaces with data transformation units or network interface controllers that are associated with software to drive the units, thereby enabling efficient data format conversion and secure transmission capabilities. The export engine 626 can communicate with or interface with other components of the data simulation platform 602, including the communication engine 612, the graph generation engine 614, the statistical analysis engine 616, the data generation engine 616, the data generation engine 618, the relationship consistency engine 620, the temporal coherence engine 622, and/or the validation engine 624.

The data simulation platform 602 (and/or components thereof) can communicate (e.g., via the network 650 and the communication engine 612) with one or more third-party databases 608a-608n. The third-party databases 608a-608n can store various types of data that can be utilized by the data simulation platform 602 for synthetic data generation, including reference datasets, validation benchmarks, regulatory compliance templates or information, industry-specific data schemas, and/or historical pattern libraries. In some implementations, the third-party databases 608a-608n include cloud-based storage systems, distributed databases, data warehouses, and/or specialized repositories that include domain-specific information relevant to the synthetic data generation process. The third-party databases 608a-608n can provide supplementary data sources that enhance the knowledge network construction, statistical modeling, and constraint generation processes performed by the data simulation platform 602. In some aspects, the third-party databases 608a-608n include secure data repositories that require authentication and authorization protocols to access sensitive or proprietary datasets (e.g., associated with financial transactions and as regulated by suitable regulatory entities). The communication between the data simulation platform 602 and the third-party databases 608a-608n can be facilitated through standardized APIs, secure data transfer protocols, or federated query mechanisms that enable seamless integration while maintaining data security and privacy requirements. The third-party databases 608a-608n can communicate with or interface with ovarious components of the environment 600, including the communication engine 612, the graph generation engine 614, the statistical analysis engine 616, the data generation engine 618, the relationship consistency engine 620, the temporal coherence engine 622, the validation engine 624, and/or the export engine 626.

For example, the data simulation platform 602 transmits the simulated node dataset (e.g., synthetic data) to a device, server, node, other entity for validation, testing, or evaluation of machine learning models associated with the system. As an illustrative example, the data simulation platform 602 provides synthetic financial trading data to regulatory compliance systems for stress-testing of risk management models. Additionally or alternatively, the data simulation platform 602 transmits synthetic microservices performance data to development environments for load-testing and capacity planning (e.g., without exposing proprietary data associated with the real system). In some implementations, the data simulation platform 602 formats the synthetic data (e.g., the simulated node dataset) according to target system requirements (e.g., by converting knowledge network representations into relational database schemas, transforming temporal sequences into time-series formats for analytical tools, or packaging synthetic datasets with associated metadata).

Engines, subsystems, or other components of the data simulation platform 602 are illustrative. As such, operations, subcomponents, or other aspects of particular subsystems (e.g., engines) of the data simulation platform 602 can be distributed, varied, or modified across other engines. In some implementations, particular engines can be deprecated, added, or removed. For example, operations associated with generation of the knowledge network can be performed at the statistical analysis engine 616, the relationship consistency engine 620, the temporal coherence engine 622, the validation engine 624 (e.g., or any suitable engine) instead of or in addition to the graph generation engine 614.

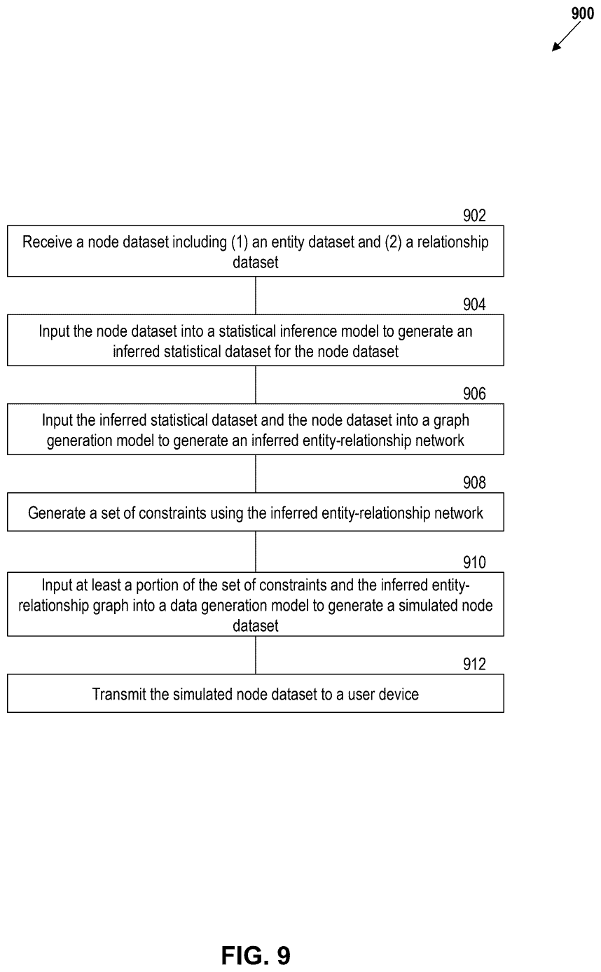

FIG. 9 illustrates an example flowchart for a process 900 for graph-driven synthetic data generation based on statistical inference of interdependencies and constraints, in accordance with one or more implementations of the disclosed technology. For example, the data simulation platform 602 receives a financial trading network dataset including prime brokers and trading desks and their associated transaction relationships. The data simulation platform can apply statistical inference to discover latent trading patterns and correlations, thereby enhancing the knowledge network with derived statistical metric values. By doing so, the data simulation platform 602 enables generation of synthetic trading data that preserves network topology and statistical properties (e.g., for subsequent testing and/or validation of adjacent machine learning models) without exposing sensitive data.

At 902, the data simulation platform 602 can receive a node dataset representing entities and associated relationships. For example, the data simulation platform 602 receives a node dataset comprising (1) an entity dataset and (2) a relationship dataset. The entity dataset can include a representation of a set of nodes and associated node values. The relationship dataset can include a representation of relationships between at least two nodes of the set of nodes. As an illustrative example, the data simulation platform 602 receives a node dataset representing a financial trading network corresponding to trading entities (e.g., prime brokers, hedge funds, and trading desks and associated computing devices). Relationships can represent transaction flows, dependency links, and/or communication patterns between the entities. By doing so, the data simulation platform 602 enables the system to capture complex interdependencies within financial networks and/or other complex, distributed systems (e.g., a distributed system of microservices), thereby improving the accuracy and realism of synthetic data generation for regulatory compliance testing, risk assessments, or other suitable validation/training operations (e.g., for associated artificial intelligence models).

At 904, the data simulation platform 602 can input the node dataset into a statistical inference model to generate an inferred statistical dataset (e.g., capturing statistical patterns, trends, or relationships within the node dataset). For example, the data simulation platform 602 inputs the node dataset into a statistical inference model to generate an inferred statistical dataset for the node dataset. The inferred statistical dataset can include (1) a set of statistical metrics and (2) a set of statistical metric values associated with the set of statistical metrics. Each statistical metric of the set of statistical metrics can be associated with one or more nodes of the set of nodes or one or more relationships of the relationship dataset. As an illustrative example, the data simulation platform 602 analyzes transaction volumes, latency patterns, and/or dependency strengths (e.g., between trading entities or microservices of a distributed network) to generate statistical metrics such as correlation coefficients between API call frequencies, average transaction processing times, and variance measures (e.g., for trading volumes across different market conditions). The statistical inference capabilities of the data simulation platform 602 enable identification of previously unknown dependencies and latent communication patterns that are not explicitly defined in the original network structure (e.g., the original microservices log data or trading network data), thereby improving the accuracy of synthetic data generation for complex distributed systems.

In some implementations, the data simulation platform 602 generates one or more statistical metric value associated with statistical measures of the received node dataset (e.g., the received financial transaction data). For example, the data simulation platform 602 determines a statistical metric, of the set of statistical metrics, between at least two values of the associated node values of the set of nodes. The statistical metric can include at least one of a univariate metric, a multivariate metric, a conditional dependency metric, an outlier characteristic metric, or a time-series statistical metric. The data simulation platform 602 can provide the node dataset to the statistical inference model to generate at least one statistical value corresponding to the determined statistical metric. The data simulation platform 602 can generate the inferred statistical dataset including the at least one statistical value associated with the statistical metric. As an illustrative example, the data simulation platform 602 (e.g., through the statistical analysis engine 616) analyzes transaction volumes between trading entities to determine correlation coefficients, variance measures, and/or outlier patterns in trading behavior across different market conditions. By incorporating multiple types of statistical metrics, the data simulation platform 602 enables more accurate detection and preservation of complex trading patterns and relationships, thereby improving the fidelity and reliability of synthetic financial data generation while maintaining privacy requirements and avoiding the use of personal or proprietary data (e.g., as regulated by relevant regulatory organizations).

At 906, the data simulation platform 602 can input the inferred statistical dataset and the node dataset into a graph generation model to generate an inferred entity-relationship network (e.g., representing ontological structures, such as trading network patterns). For example, the data simulation platform 602 inputs the inferred statistical dataset and the node dataset into a graph generation model to generate an inferred entity-relationship network including (1) a set of inferred node identifiers corresponding to a set of inferred nodes and (2) a set of inferred node relationships. The inferred entity-relationship network can include an indication of structural, semantic, and statistical properties of the node dataset. The indication of the structural, semantic, and statistical properties can be consistent with the inferred statistical dataset. Each relationship of the set of inferred node relationships can indicate a particular relationship label between at least two particular nodes of the set of inferred nodes. As an illustrative example, the data simulation platform 602 generates an inferred entity-relationship network for a financial trading network that captures explicit relationships (e.g., direct trading partnerships or communications between prime brokers and hedge funds) and latent statistical dependencies (e.g., correlated trading volumes during market volatility events), thereby enabling the system to represent complex multi-dimensional trading behaviors that emerge from statistical analysis of transaction patterns. By leveraging a bidirectional integration layer between generated knowledge networks and statistical inferences, the data simulation platform 602 enables enhanced, accurate modelling of real-world systems (e.g., financial system dynamics and/or dynamics within a distributed mesh of microservices).

At 908, the data simulation platform 602 can generate a set of constraints based on the inferred entity-relationship network. For example, the data simulation platform 602 generates, using the inferred entity-relationship network, a set of constraints for generation of simulated data. As an illustrative example, the data simulation platform 602 generates constraints that ensure that synthetic trading data maintains realistic transaction volume ratios (e.g., between prime brokers and associated hedge funds). For example, the data simulation platform 602 preserves the temporal ordering of market events and can enforce regulatory requirements across generated trading entities. In some implementations, the data simulation platform 602 generates a range of acceptable values for given attributes or factors associated with the node dataset, such as minimum and maximum transaction volumes, correlation thresholds between related entities, temporal dependencies that are maintained between sequential events, and structural integrity requirements, thereby ensuring referential consistency between interconnected nodes within the synthetic data generation process, even when associated constraints are latent.

In some implementations, the data simulation platform 602 uses relationship sampling algorithms to determine constraining relationships to be reflected in the synthetic data generated. For example, the data simulation platform 602 determines a relationship sampling algorithm comprising at least one of: a Gibbs sampling algorithm, a Metropolis-Hastings algorithm, or a Variational Inference algorithm. The data simulation platform 602 can apply the relationship sampling algorithm to the received node dataset to determine a relationship constraint set associated with the set of inferred node relationships. The data simulation platform 602 can generate the set of constraints including the relationship constraint set. As an illustrative example, the data simulation platform 602 applies Gibbs sampling to iteratively sample trading relationships between financial entities, ensuring that synthetic transaction flows maintain realistic dependency structures (e.g., between prime brokers, hedge funds, and trading desks), while preserving context-specific (e.g., market-specific) correlation patterns observed in the original trading network. By doing so, the data simulation platform 602 can generate synthetic data that maintains complex interdependencies necessary for training and validation of models (e.g., that enable stress testing and risk assessment modeling) in distributed systems (e.g., financial trading networks and/or distributed meshes of microservices).

In some implementations, the data simulation platform 602 embeds the relationship using an embedding model to generate the relationship-based constraint. For example, the data simulation platform 602 inputs the received node dataset into a constraint generation model to generate a relationship embedding set with respect to the received node dataset. Each relationship embedding of the relationship embedding set can characterize a corresponding inferred node relationship of the set of inferred node relationships. The relationship embedding set can include at least one of (1) a graph neural network embedding, (2) a relationship-type embedding, (3) a contextual-relationship embedding, and (4) a temporal relationship embedding. The data simulation platform 602 can generate the relationship constraint set including the relationship embedding set. As an illustrative example, the data simulation platform 602 generates graph neural network embeddings that capture hierarchical relationships between trading desks and parent institutions, relationship-type embeddings that distinguish between different transaction or relationship categories (e.g., equity trades, derivatives, repo agreements, etc.), and temporal embeddings that encode time-dependent trading patterns during market openings and closing periods. The embedding-based constraint generation enables preservation of nuanced relationship semantics that are computationally difficult to represent through traditional rule-based approaches, thereby improving the technical accuracy of synthetic data generation for complex financial network modeling applications.

At 910, the data simulation platform 602 can input at least a portion of the set of constraints and the inferred entity-relationship network into a data generation model to generate a simulated node dataset. For example, the data simulation platform 602 inputs at least a portion of the set of constraints and the inferred entity-relationship network into a data generation model to generate a simulated node dataset consistent with the set of constraints and the inferred entity-relationship network. As an illustrative example, the data simulation platform 602 generates synthetic trading data (e.g., for a high-frequency trading network) where the simulated dataset maintains the hierarchical structure of entity relationships, as well as statistical properties (e.g., associated with transaction volumes, latencies, and market correlations observed in the original trading network). The constraint-guided generation process enables creation of technically accurate synthetic datasets that preserve complex financial system dynamics while ensuring regulatory compliance, thereby enabling stress-testing without exposing sensitive or proprietary trading information.

In some implementations, the data simulation platform 602 leverages a specialized model to generate the synthetic data. For example, the data simulation platform 602 determines a specialized generative model set associated with the data generation model. Each specialized generative model of the specialized generative model set can be associated with a particular model specialization of a model specialization set. The data simulation platform 602 can generate, based on: (1) the inferred entity-relationship network, (2) the set of constraints, and (3) the model specialization set, a portion set. Each portion of the portion set can correspond to a particular portion of the inferred entity-relationship network or a particular portion of the set of constraints. Each portion of the portion set can be associated with a corresponding model specialization of the model specialization set. The data simulation platform 602 can provide each portion of the portion set to a corresponding specialized generative model of the specialized generative model set that is associated with a corresponding model specialization of the model specialization set to generate a model output set. The data simulation platform 602 can generate the simulated node dataset including the model output set. As an illustrative example, the data simulation platform 602 employs specialized graph neural networks for modelling hierarchical trading relationships, variational autoencoders for generating transaction volume distributions, and/or transformer models for preserving temporal trading frequencies within a high-frequency trading environment. The modular specialization enables parallel processing of different aspects of the real-world data, while maintaining consistency across the entire synthetic dataset, thereby reducing computational complexity and improving scalability for large-scale financial network simulation applications.

In some implementations, the data simulation platform 602 can integrate temporal data to generate constraints that reflect temporal patterns within the real-world data. For example, the data simulation platform 602 determines time-series data associated with the node dataset. Each data point of the time-series data can be associated with a particular timestamp of a set of timestamps. The data simulation platform 602 can provide the time-series data and at least two of the node dataset, the inferred entity-relationship network, the set of constraints, or the inferred statistical dataset to a temporal coherence model to generate a temporal dependency graph consistent with the time-series data. The temporal dependency graph can identify at least one of a temporal dependency constraint, a sequence progression constraint, or a time-based correlation. The data simulation platform 602 can provide the inferred entity-relationship network, the temporal dependency graph, and the set of constraints to the data generation model to generate the simulated node dataset consistent with the set of constraints, the inferred entity-relationship network, and the temporal dependency graph. As an illustrative example, the data simulation platform 602 analyzes time-series trading data from a high-frequency trading network to generate temporal dependency graphs capturing sequential market events, such as order placement patterns (e.g., during market volatility periods) and the cascading effects of large block trades across interconnected trading desks. The temporal coherence modeling enables the platform to generate synthetic datasets that preserve realistic time-dependent trading behaviors and causal relationships, thereby improving the technical accuracy of synthetic data for training machine learning models to be used in algorithmic trading systems, risk assessment applications, or other suitable models.

In some implementations, the data simulation platform 602 generates the simulated node dataset in a manner that preserves the distribution of anomalies in the underlying real-world dataset (e.g., the node dataset). For example, the data simulation platform 602 can leverage an anomaly preservation framework to preserve temporal anomalies associated with the correct temporal context.

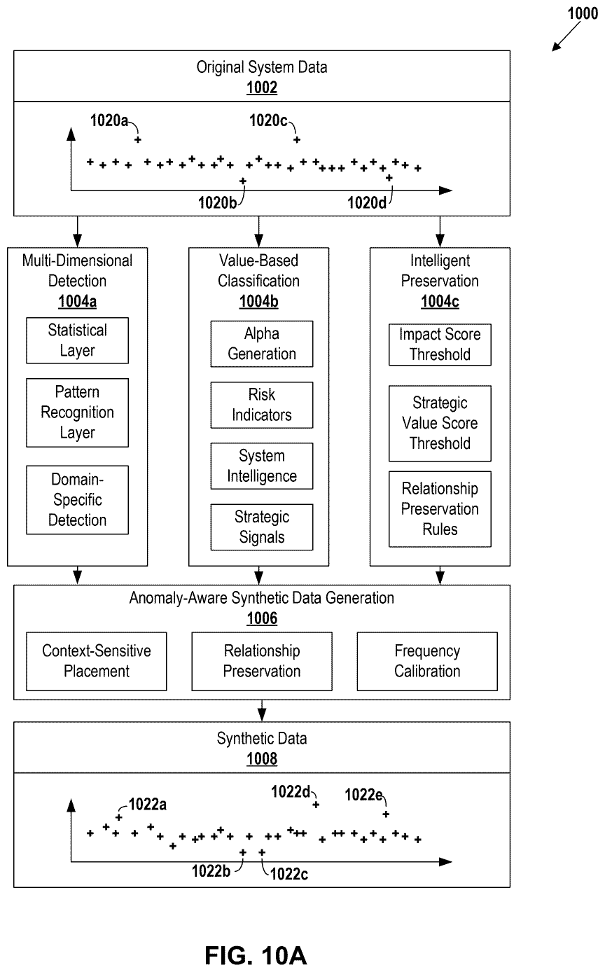

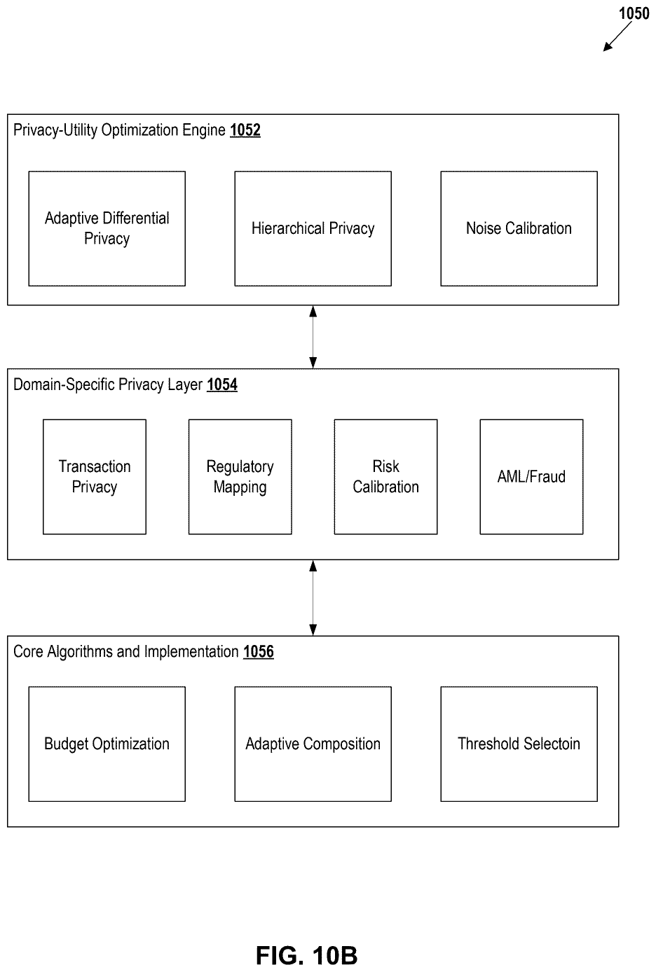

FIG. 10A illustrates an example architecture for an anomaly preservation framework 1000 associated with the data simulation platform, in accordance with one or more implementations of the disclosed technology. For example, the data simulation platform 602, via the anomaly preservation platform, receives a real-world dataset (e.g., the node dataset) corresponding to the original system data 1002. The original system data 1002 can include financial market data, including temporal anomalies (e.g., anomalies 1020a-1020d). To illustrate, anomalies can include arbitrage opportunities, liquidity anomalies, break correlation anomalies, and/or risk event anomalies associated with financial market timeseries data.

In some implementations, the anomaly preservation framework 1000 enables the data simulation platform 602 to perform multi-dimensional detection at a module 1004a. For example, the module 1004a enables recognition of statistical information (e.g., at a statistical layer), patterns (e.g., at a pattern recognition layer), or domain-specific information (e.g., at a domain-specific detection layer) within the original system data 1002. For example, the data simulation platform detects statistical, pattern-based, and/or domain-specific anomalies within the original system data 1002.

In some implementations, the anomaly preservation framework 1000 enables value-based classification of the real-world data represented within the original system data 1002 using a module 1004b. For example, the data simulation platform can generate and/or measure alphas associated with a financial market (e.g., representing an excess return on investment in relation to a benchmark). The data simulation platform can generate risk indicators (e.g., associated with a particular market or market structure), leverage system intelligence, and detect strategic signals associated with the financial market data. By generating or recording such information relating to the real-world data, the data simulation platform enables characterization of anomalies within the real-world data that can be subsequently simulated within the generated simulated data (e.g., synthetic financial data), thereby enabling testing and validation of anomaly-related system performance.

In some implementations, the anomaly preservation framework 1000 enables intelligent preservation of aspects of the real-world data within the generated simulated data (e.g., using a module 1004c). For example, the data simulation platform can, using module 1004c, determine that a financial impact score is greater than or equal to a particular threshold value, determine that a strategic value score is greater than or equal to another particular threshold value, and/or determine relationships between variables or data points within the data for preservation within the simulated data (e.g., the simulated node dataset). As an illustrative example, the data simulation platform determines the economic significance value of a particular anomaly (e.g., a loss magnitude or a measure of the market disruption) and determine to preserve anomalies that are greater than a threshold economic significance value. Additionally or alternatively, the data simulation platform can measure the relevance of a particular anomaly (e.g., one or more of anomalies 1020a-1020d) to a particular strategic objective (e.g., risk management, regulatory compliance, and/or model robustness) and generate a strategic object relevance metric accordingly. The data simulation platform can compare the strategic object relevance metric to a particular threshold metric to determine whether to preserve the anomaly. Based on satisfaction of one or more thresholds, the data simulation platform (e.g., via the module 1004c of the anomaly preservation framework 1000) can generate relationship preservation rules that preserve relationships and associated anomalies within generated synthetic data that is based on the real-world system data (e.g., the node dataset or original financial market data). In some implementations, the data simulation platform represents the relationship preservation rules, including associated anomaly information (e.g., the multi-dimensional detection, value-based classification, or intelligent preservation data), within an inferred entity-relationship network (e.g., an inferred node map, as described above). Additionally or alternatively, the data simulation platform represents the anomaly-related information within the set of constraints derived from the entity-relationship network.

The anomaly preservation framework 1000 enables the data simulation platform to execute anomaly-aware synthetic data generation at the module 1006 of FIG. 10A. For example, the data simulation platform generates the simulated node dataset (e.g., the simulated financial data) based on the real-world data by placing simulated anomalies, based on the anomaly-related information (and/or associated relationship preservation rules or constraints), within the simulated dataset in a context-sensitive manner. In some implementations, the generated simulated dataset is consistent with relationship preservation rules and, therefore, preserves statistical, pattern-based, and anomaly-related information derived from the real-world dataset. The data simulation platform can calibrate the frequency of associated anomalies based on the multi-dimensional detection (e.g., from the module 1004a), the value-based classification (e.g., from the module 1004b) and/or the intelligent preservation (e.g., from the module 1004c). For example, the data simulation platform determines a temporal frequency associated with a particular anomaly type (e.g., arbitrage opportunity-related anomaly, a liquidity anomaly, a break correlation-related anomaly, and/or a risk event-related anomaly) and generates, within the simulated dataset, anomalies according to the determined temporal frequencies.

To illustrate, the generated synthetic data 1008 of FIG. 10A includes anomalies 1022a-1022e that reflect the statistical information, patterns, domain-specific information, alphas, risk indicators, system intelligence, strategic signals, relationship preservation rules, context-information, and anomaly frequencies of the original system data 1002. For example, 1022a and 1022e reflects arbitrage opportunity-related anomalies temporally separated in a manner that reflects the average anomaly frequency for arbitrage opportunities within the real-world, original system data 1002 (e.g., original financial market data).

FIG. 10B illustrates an example of a privacy preservation framework 1050 associated with the data simulation platform, in accordance with one or more implementations of the disclosed technology. In some implementations, the data simulation platform leverages adaptive privacy controls to protect exposure of real-world data (e.g., the node dataset) to unauthorized computing systems. As an illustrative example, the data simulation platform leverages a privacy-utility optimization engine 1052, a financial services privacy layer 1054, and/or a core algorithms and implementation module 1056.

To illustrate, the privacy-utility optimization engine 1052 leverages a differential privacy framework to enable the release of statistical information relating to a dataset while protecting the privacy of individual subjects of data. To illustrate, the data simulation platform injects calibrated noise into statistical computations such that the utility of the statistic is preserved, while limiting what can be inferred about any individual in the dataset. A change to a particular entry in the generated simulated dataset only creates a small change in the probability distribution of the outputs of statistical measures. In some implementations, the data simulation platform dynamically determines a differential privacy parameter value (e.g., a privacy budget represented by ε) dynamically to control the amount of noise injected into the simulated dataset by data type, time, or dataset feature. For example, the data simulation platform 602 assigns a differential privacy parameter value based on the an event type within the dataset, as well as the desired privacy level. The data simulation platform 602 can assign a relatively high sensitivity (e.g., associated with a relatively low & value) to large trade events to improve the privacy and security for discrete events, while using a relatively high & value for aggregated daily volume data that does not require high levels of privacy.

In some implementations, the privacy-utility optimization engine 1052 enables the data simulation platform 602 to perform a sensitivity analysis to validate and/or configure the differential privacy parameter value. For example, the data simulation platform 602 perturbs the simulated data (e.g., by removing a particular data entry or other data element) and determines a resulting change in the statistical properties of the simulated dataset to determine a sensitivity value for the particular dataset and/or data element of the dataset. In some implementations, the data simulation platform 602 adjusts the differential privacy parameter value (e.g., the privacy budget) in response to determining the sensitivity value for the dataset. The data simulation platform 602 can implement temporal decay functions to assign a lower privacy budget value (e.g., a lower & value) to recent or real-time data, as such data can be more sensitive. As such, the data simulation platform 602 can adjust the privacy budget according to the sensitivity and/or temporal features associated with the dataset.

In some implementations, the privacy-utility optimization engine 1052 determines privacy or exposure mitigation features in a hierarchical manner. For example, the data simulation platform 602 determines privacy controls particular to various levels (e.g., at a global level, an entity level, or an attribute level). The corresponding level-specific controls can include privacy budgets (e.g., & values) particular to each level, each entity, and/or each attribute. In some implementation, the privacy preservation framework 1050 enables cascading guarantees (e.g., enabling privacy guarantees at higher levels, such as globally, to cascade down to lower levels, such as to the attribute or entity). For example, the data simulation platform 602 exerts a constraint such that a sum of privacy losses at lower levels does not exceed the upper-level budget. In some implementations, the data simulation platform enables granular optimization of privacy controls associated with data elements at different levels (e.g., at each hierarchical level) based on data sensitivity, utility, and age. In some implementations, the granular optimization is dynamically performed.

In some implementations, the privacy-utility optimization engine 1052 enables noise calibration for generation of the simulated dataset. For example, the data simulation platform 602 enables dynamic adjustment of noise magnitude within the simulated dataset based on the context (e.g., data sensitivity, temporal relevance, or anomaly presence). For example, recent, high-impact trades associated with the real-world dataset receive more noise, while less sensitive historical data receives less noise. By doing so, the privacy-utility optimization engine enables context-aware scaling of privacy controls applied to the various elements or levels within the simulated dataset. In some implementations, the privacy preservation framework 1050, through the privacy-utility optimization engine 1052, applies asymmetric distributions to model real-world data characteristics or to minimize distortions in particular directions of the simulated data. For example, in financial data, negative outliers can be more critical, significant, or consequential than positive outliers. As such, a skewed noise distribution enables preservation and/or configuration of statistical tail behavior within the simulated dataset. In some implementations, the privacy-utility optimization engine enables calibration of noise within the dataset to minimize utility loss metrics for defined analytical tasks (e.g., anomaly detection, risk modeling, etc.). For example, the data simulation platform 602 performs task-aware calibration of noise or adaptive epsilon allocation (e.g., of privacy budgets) based on the context of a particular task associated with the simulated data. In some implementations, the data simulation platform 602, through the privacy-utility optimization engine 1052, imposes domain constraints that limit or configure the application of noise to the simulated data. For example, the domain constraints set valid data ranges to prevent unrealistic or infeasible simulated data values. As such, the privacy-utility optimization engine enables configuration of statistical features (e.g., noise) that enable privacy protection and exposure mitigation associated with sensitive data features of the real-world data underlying the simulated data.

The privacy preservation framework 1050 can include a domain-specific privacy layer 1054 that enables protection of particular, domain-specific features of the real-world dataset and associated simulated dataset. For example, the domain-specific privacy layer 1054 includes a transaction privacy layer that defines privacy budgets associated with different elements of transactions (e.g., transaction amounts, merchants, timestamps, and locations) within the real-world dataset. In some implementations, the domain-specific privacy layer 1054 includes a regulatory mapping module enabling compliance with different regulatory regimes, such as PCI-DSS, GDPR, Basel II rules, and/or SOX audit trails. In some implementations, the domain-specific privacy layer 1054 enables risk calibration based on impact assessments, probability scoring, and sensitivity analyses, thereby enabling dynamic adjustment of privacy controls and other related parameter values. In some implementations, the privacy preservation framework 1050 includes anti-money laundering or anti-fraud features, including pattern preservation, anomaly retention, network analysis, and alert thresholds. To illustrate, the privacy preservation framework 1050 (e.g., via the core algorithms and implementation module 1056) leverages algorithms including budget optimization, adaptive composition, and threshold selection to enable domain-specific privacy-utility optimization and exposure mitigation.

In some implementations, the data simulation platform 602 generates constraints with different priority levels and generate the synthetic data such that it is consistent with certain constraints depending on their priority levels. For example, the data simulation platform 602 generates the set of constraints. A first constraint subset of the set of constraints can be associated with a first constraint priority level. A second constraint subset of the set of constraints can be associated with a second constraint priority level. The data simulation platform 602 can determine a system status indicating a computational resource usage level associated with the computing system. The data simulation platform 602 can determine, using the system status, a priority threshold level. The data simulation platform 602 can determine that the first constraint priority level satisfies the priority threshold level and that the second constraint priority level does not satisfy the priority threshold level. In response to determining that the first constraint priority level satisfies the priority threshold level and the second constraint priority level does not satisfy the priority threshold level, the data simulation platform 602 can input the first constraint subset into the data generation model to generate the simulated node dataset. The simulated node dataset is consistent with the first constraint subset and not consistent with the second constraint subset. As an illustrative example, the data simulation platform 602 prioritizes regulatory compliance constraints (e.g., capital adequacy ratios, position limits, etc.) over optimization constraints (e.g., constraints that improve the performance or scalability of the synthetic data generation system) when computational resources are not limited. Additionally or alternatively, the data simulation platform 602 also prioritizes optimization constraints when the data simulation platform 602 detects that system resource usage is high (e.g., above a particular usage threshold). The adaptive constraint prioritization mechanism enables maintenance of computational efficiency while preserving technically important data characteristics for training or validation of the target models.

In some implementations, the data simulation platform 602 leverages a topological sort to determine portions of the synthetic data to generate preferentially to other portions. For example, the data simulation platform 602 determines, within the inferred entity-relationship network, at least two inferred nodes of the set of inferred nodes that are associated with a first inferred relationship of the set of inferred node relationships. In response to determining the at least two inferred nodes, the data simulation platform 602 can determine a topological sort of portions of the inferred entity-relationship network. A first portion of the inferred entity-relationship network can include the at least two inferred nodes and the first inferred relationship. The data simulation platform 602 can input, in an order consistent with the topological sort, the portions of the inferred entity-relationship network into the data generation model to generate the simulated node dataset. The at least two inferred nodes and the first inferred relationship can be input into the data generation model simultaneously. As an illustrative example, the data simulation platform 602 first processes a financial trading network by generating synthetic data for prime brokers (e.g., with no dependencies). Subsequently, the data simulation platform 602 generates synthetic data associated with hedge funds (e.g., which depend on prime brokers) and, finally, individual trading desks (e.g., which can depend on both prime brokers and hedge funds). By doing so, the dependent entities are generated in a manner that improves the accuracy and business logic of the financial transaction network, enabling the platform to maintain referential integrity and dependency constraints during synthetic data generation, reducing the computational overhead and preventing the generation of invalid entity relationships that would compromise the structural, statistical, or semantic validity of the synthetic financial network.

At 912, the data simulation platform 602 can transmit the simulated node dataset to a user device. For example, the data simulation platform 602 transmits the simulated node dataset to a user device to cause validation or training, using the simulated node dataset, of an artificial intelligence model. As an illustrative example, the data simulation platform 602 transmits synthetic high-frequency trading data to regulatory compliance systems for automated stress-testing of capital adequacy models or to machine learning development environments for algorithmic trading systems without exposing proprietary marketing strategies or regulatorily protected information. As such, the data simulation platform 602 enables automated integration with downstream analytical streams, improving the technical efficiency of model validation workflows in distributed computing environments.

In some implementations, the data simulation platform 602 performs validations of the generated synthetic data based on structural, statistical, and/or semantic properties of the synthetic data. For example, the data simulation platform 602 inputs the simulated node dataset into a validation model to generate a validation report for the simulated node dataset. The validation report can include an indication of at least one of: (1) a structural validation status comprising an indication of whether the simulated node dataset is consistent with the inferred entity-relationship network and the set of constraints, (2) a statistical validation status comprising an indication of whether the simulated node dataset is consistent with the inferred statistical dataset, or (3) a semantic validation status comprising an indication of whether the simulated node dataset is consistent with rule-based constraints associated with the set of constraints. The data simulation platform 602 can input the simulated node dataset, the inferred entity-relationship network, and the validation report into the data generation model to generate an updated simulated node dataset, consistent with the inferred entity-relationship network and based on the simulated node dataset and the validation report. As an illustrative example, the data simulation platform 602 validates synthetic trading data by verifying relationships between particular entities within the knowledge network (e.g., structural validation), that transactions comply with regulatory requirements (e.g., semantic validation), and/or that transaction volume distributions and other statistical metrics are consistent with historical patterns (e.g., statistical validation). The validation framework enables the platform to ensure that synthetic data quality and regulatory compliance are maintained in automated financial system testing environments, thereby providing a technical solution to validating complex financial models without exposing sensitive or proprietary information.

### Conclusion

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number, respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples; alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology can include additional elements to those implementations noted above or can include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system can vary considerably in its specific implementation while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects can likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right after filing this application to pursue such additional claim forms, either in this application or in a continuing application.

From the foregoing, it will be appreciated that specific implementations of the invention have been described herein for purposes of illustration, but that various modifications can be made without deviating from the scope of the invention. Accordingly, the invention is not limited except as by the appended claims.

1. A computing system comprising:
one or more processors; and
one or more non-transitory, computer-readable storage media storing instructions that, when executed by the one or more processors, cause the computing system to:
receive a node dataset comprising (1) an entity dataset and (2) a relationship dataset,
wherein the entity dataset comprises a representation of a set of nodes and associated node values, and
wherein the relationship dataset includes a representation of relationships between at least two nodes of the set of nodes;
input the node dataset into a statistical inference model to generate an inferred statistical dataset for the node dataset,
wherein the inferred statistical dataset includes (1) a set of statistical metrics and (2) a set of statistical metric values associated with the set of statistical metrics,
wherein each statistical metric of the set of statistical metrics is associated with one or more nodes of the set of nodes or one or more relationships of the relationship dataset, and
wherein the set of statistical metric values includes at least one correlation coefficient value corresponding to a correlation between a first and second node of the set of nodes;
input the inferred statistical dataset and the node dataset into a graph generation model to generate an inferred entity-relationship network including (1) a set of inferred node identifiers corresponding to a set of inferred nodes and (2) a set of inferred node relationships,
wherein the inferred entity-relationship network includes an indication of structural, semantic, and statistical properties of the node dataset,
wherein the indication of the structural, semantic, and statistical properties is consistent with the inferred statistical dataset,
wherein each relationship of the set of inferred node relationships indicates a particular relationship label between at least two particular nodes of the set of inferred nodes, and
wherein generating the inferred entity-relationship network comprises modifying the relationship dataset based on the inferred statistical dataset, including:
adding, to the inferred entity-relationship network and based on the at least one correlation coefficient value between the first and second nodes, an inferred relationship between the first and second nodes when the inferred relationship is not included in the relationship dataset, and
excluding, from the inferred entity-relationship network, a relationship of the relationship dataset when an explicit correlation associated with the relationship is not statistically significant;
generate, using the inferred entity-relationship network, a set of constraints for generation of simulated data;
input at least a portion of the set of constraints and the inferred entity-relationship network into a data generation model to generate a simulated node dataset consistent with the set of constraints and the inferred entity-relationship network including the inferred relationship,
wherein the generated simulated node dataset exhibits the at least one correlation coefficient value of the inferred statistical dataset for the node dataset; and
transmit the simulated node dataset to a user device to cause validation or training, using the simulated node dataset, of an artificial intelligence model.

2. The computing system of claim 1, wherein the instructions for generating the simulated node dataset cause the computing system to:
determine a specialized generative model set associated with the data generation model,
wherein each specialized generative model of the specialized generative model set is associated with a particular model specialization of a model specialization set;
generate, based on: (1) the inferred entity-relationship network, (2) the set of constraints, and (3) the model specialization set, a portion set,
wherein each portion of the portion set corresponds to a particular portion of the inferred entity-relationship network or a particular portion of the set of constraints, and
wherein each portion of the portion set is associated with a corresponding model specialization of the model specialization set;
provide each portion of the portion set to a corresponding specialized generative model of the specialized generative model set that is associated with a corresponding model specialization of the model specialization set to generate a model output set; and
generate the simulated node dataset including the model output set.

3. The computing system of claim 1, wherein the instructions for generating the inferred statistical dataset cause the computing system to:
determine a statistical metric, of the set of statistical metrics, between at least two values of the associated node values of the set of nodes,
wherein the statistical metric includes at least one of a univariate metric, a multivariate metric, a conditional dependency metric, an outlier characteristic metric, or a time-series statistical metric;
provide the node dataset to the statistical inference model to generate at least one statistical value corresponding to the determined statistical metric; and
generate the inferred statistical dataset including the at least one statistical value associated with the statistical metric.

4. The computing system of claim 1, wherein the instructions for generating the simulated node dataset cause the computing system to:
determine time-series data associated with the node dataset,
wherein each data point of the time-series data is associated with a particular timestamp of a set of timestamps;
provide the time-series data and at least two of the node dataset, the inferred entity-relationship network, the set of constraints, or the inferred statistical dataset to a temporal coherence model to generate a temporal dependency graph consistent with the time-series data,
wherein the temporal dependency graph identifies at least one of a temporal dependency constraint, a sequence progression constraint, or a time-based correlation; and
provide the inferred entity-relationship network, the temporal dependency graph, and the set of constraints to the data generation model to generate the simulated node dataset consistent with the set of constraints, the inferred entity-relationship network, and the temporal dependency graph.

5. The computing system of claim 1, wherein the instructions for generating the simulated node dataset consistent with the set of constraints cause the computing system to:
generate the set of constraints,
wherein a first constraint subset of the set of constraints is associated with a first constraint priority level, and
wherein a second constraint subset of the set of constraints is associated with a second constraint priority level;
determine a system status indicating a computational resource usage level associated with the computing system;
determine, using the system status, a priority threshold level;
determine that the first constraint priority level satisfies the priority threshold level and that the second constraint priority level does not satisfy the priority threshold level; and
in response to determining that the first constraint priority level satisfies the priority threshold level and the second constraint priority level does not satisfy the priority threshold level, input the first constraint subset into the data generation model to generate the simulated node dataset,
wherein the simulated node dataset is consistent with the first constraint subset and not consistent with the second constraint subset.

6. The computing system of claim 1, wherein the instructions for generating the simulated node dataset cause the computing system to:
determine, within the inferred entity-relationship network, at least two inferred nodes of the set of inferred nodes that are associated with a first inferred relationship of the set of inferred node relationships;
in response to determining the at least two inferred nodes, determine a topological sort of portions of the inferred entity-relationship network,
wherein a first portion of the inferred entity-relationship network includes the at least two inferred nodes and the first inferred relationship; and
input, in an order consistent with the topological sort, the portions of the inferred entity-relationship network into the data generation model to generate the simulated node dataset,
wherein the at least two inferred nodes and the first inferred relationship are input into the data generation model simultaneously.

7. The computing system of claim 1, wherein the instructions for generating the set of constraints cause the computing system to:
determine a relationship sampling algorithm comprising at least one of: a Gibbs sampling algorithm, a Metropolis-Hastings algorithm, or a Variational Inference algorithm;
apply the relationship sampling algorithm to the received node dataset to determine a relationship constraint set associated with the set of inferred node relationships; and
generate the set of constraints including the relationship constraint set.

8. The computing system of claim 7, wherein the instructions for determining the relationship constraint set cause the computing system to:
input the received node dataset into a constraint generation model to generate a relationship embedding set with respect to the received node dataset,
wherein each relationship embedding of the relationship embedding set characterizes a corresponding inferred node relationship of the set of inferred node relationships,
wherein the relationship embedding set comprises at least one of (1) a graph neural network embedding, (2) a relationship-type embedding, (3) a contextual-relationship embedding, and (4) a temporal relationship embedding; and
generate the relationship constraint set including the relationship embedding set.

9. The computing system of claim 1, wherein the instructions further cause the computing system to:
input the simulated node dataset into a validation model to generate a validation report for the simulated node dataset,
wherein the validation report includes an indication of at least one of:
(1) a structural validation status comprising an indication of whether the simulated node dataset is consistent with the inferred entity-relationship network and the set of constraints,
(2) a statistical validation status comprising an indication of whether the simulated node dataset is consistent with the inferred statistical dataset, or
(3) a semantic validation status comprising an indication of whether the simulated node dataset is consistent with rule-based constraints associated with the set of constraints; and
input the simulated node dataset, the inferred entity-relationship network, and the validation report into the data generation model to generate an updated simulated node dataset, consistent with the inferred entity-relationship network and based on the simulated node dataset and the validation report.

10. One or more non-transitory, computer-readable storage media storing instructions that, when executed by one or more processors of a computing system, cause the computing system to:
receive a node dataset comprising (1) an entity dataset and (2) a relationship dataset,
wherein the entity dataset comprises a representation of a set of nodes and associated node values, and
wherein the relationship dataset includes a representation of relationships between at least two nodes of the set of nodes;
provide the node dataset to a statistical inference model to generate an inferred statistical dataset for the node dataset,
wherein the inferred statistical dataset includes (1) a set of statistical metrics and (2) a set of statistical metric values associated with the set of statistical metrics, and
wherein the set of statistical metric values includes at least one correlation coefficient value corresponding to a correlation between a first and second node of the set of nodes;
provide the inferred statistical dataset and the node dataset to a graph generation model to generate an inferred entity-relationship network including (1) a set of inferred node identifiers corresponding to a set of inferred nodes and (2) a set of inferred node relationships,
wherein the inferred entity-relationship network includes an indication of structural, semantic, and statistical properties of the node dataset,
wherein the indication of the structural, semantic, and statistical properties is consistent with the inferred statistical dataset,
wherein each relationship of the set of inferred node relationships indicates a particular relationship label between at least two particular nodes of the set of inferred nodes, and
wherein generating the inferred entity-relationship network comprises modifying the relationship dataset based on the inferred statistical dataset, including:
adding, to the inferred entity-relationship network and based on the at least one correlation coefficient value between the first and second nodes, an inferred relationship between the first and second nodes when the inferred relationship is not included in the relationship dataset, and
excluding, from the inferred entity-relationship network, a relationship of the relationship dataset when an explicit correlation associated with the relationship is not statistically significant;
generate, using the inferred entity-relationship network, a set of constraints for generation of simulated data;
provide at least a portion of the set of constraints and the inferred entity-relationship network to a data generation model to generate a simulated node dataset consistent with the set of constraints and the inferred entity-relationship network including the inferred relationship,
wherein the generated simulated node dataset exhibits the at least one correlation coefficient value of the inferred statistical dataset; and
transmit the simulated node dataset to a user device to cause validation or training, using the simulated node dataset, of an artificial intelligence model.

11. The one or more non-transitory, computer-readable storage media of claim 10, wherein the instructions for generating the simulated node dataset cause the computing system to:
determine a specialized generative model set associated with the data generation model,
wherein each specialized generative model of the specialized generative model set is associated with a particular model specialization of a model specialization set;
generate, based on: (1) the inferred entity-relationship network, (2) the set of constraints, and (3) the model specialization set, a portion set,
wherein each portion of the portion set corresponds to a particular portion of the inferred entity-relationship network or a particular portion of the set of constraints, and
wherein each portion of the portion set is associated with a corresponding model specialization of the model specialization set;
provide each portion of the portion set to a corresponding specialized generative model of the specialized generative model set that is associated with a corresponding model specialization of the model specialization set to generate a model output set; and
generate the simulated node dataset including the model output set.

12. The one or more non-transitory, computer-readable storage media of claim 10, wherein the instructions for generating the inferred statistical dataset cause the computing system to:
determine a statistical metric, of the set of statistical metrics, between at least two values of the associated node values of the set of nodes,
wherein the statistical metric includes at least one of a univariate metric, a multivariate metric, a conditional dependency metric, an outlier characteristic metric, or a time-series statistical metric;
provide the node dataset to the statistical inference model to generate at least one statistical value corresponding to the determined statistical metric; and
generate the inferred statistical dataset including the at least one statistical value associated with the statistical metric.

13. The one or more non-transitory, computer-readable storage media of claim 10, wherein the instructions for generating the simulated node dataset cause the computing system to:
determine time-series data associated with the node dataset,
wherein each data point of the time-series data is associated with a particular timestamp of a set of timestamps;
provide the time-series data and at least two of the node dataset, the inferred entity-relationship network, the set of constraints, or the inferred statistical dataset to a temporal coherence model to generate a temporal dependency graph consistent with the time-series data,
wherein the temporal dependency graph identifies at least one of a temporal dependency constraint, a sequence progression constraint, or a time-based correlation; and
provide the inferred entity-relationship network, the temporal dependency graph, and the set of constraints to the data generation model to generate the simulated node dataset consistent with the set of constraints, the inferred entity-relationship network, and the temporal dependency graph.

14. The one or more non-transitory, computer-readable storage media of claim 10, wherein the instructions for generating the simulated node dataset consistent with the set of constraints cause the computing system to:
generate the set of constraints,
wherein a first constraint subset of the set of constraints is associated with a first constraint priority level, and
wherein a second constraint subset of the set of constraints is associated with a second constraint priority level;
determine a system status indicating a computational resource usage level associated with the computing system;
determine, using the system status, a priority threshold level;
determine that the first constraint priority level satisfies the priority threshold level and that the second constraint priority level does not satisfy the priority threshold level; and
in response to determining that the first constraint priority level satisfies the priority threshold level and the second constraint priority level does not satisfy the priority threshold level, input the first constraint subset into the data generation model to generate the simulated node dataset,
wherein the simulated node dataset is consistent with the first constraint subset and not consistent with the second constraint subset.

15. The one or more non-transitory, computer-readable storage media of claim 10, wherein the instructions for generating the simulated node dataset cause the computing system to:
determine, within the inferred entity-relationship network, at least two inferred nodes of the set of inferred nodes that are associated with a first inferred relationship of the set of inferred node relationships;
in response to determining the at least two inferred nodes, determine a topological sort of portions of the inferred entity-relationship network,
wherein a first portion of the inferred entity-relationship network includes the at least two inferred nodes and the first inferred relationship; and
input, in an order consistent with the topological sort, the portions of the inferred entity-relationship network into the data generation model to generate the simulated node dataset,
wherein the at least two inferred nodes and the first inferred relationship are input into the data generation model simultaneously.

16. The one or more non-transitory, computer-readable storage media of claim 10, wherein the instructions for generating the set of constraints cause the computing system to:
determine a relationship sampling algorithm comprising at least one of: a Gibbs sampling algorithm, a Metropolis-Hastings algorithm, or a Variational Inference algorithm;
apply the relationship sampling algorithm to the received node dataset to determine a relationship constraint set associated with the set of inferred node relationships; and
generate the set of constraints including the relationship constraint set.

17. The one or more non-transitory, computer-readable storage media of claim 16, wherein the instructions for determining the relationship constraint set cause the computing system to:
input the received node dataset into a constraint generation model to generate a relationship embedding set with respect to the received node dataset,
wherein each relationship embedding of the relationship embedding set characterizes a corresponding inferred node relationship of the set of inferred node relationships,
wherein the relationship embedding set comprises at least one of (1) a graph neural network embedding, (2) a relationship-type embedding, (3) a contextual-relationship embedding, and (4) a temporal relationship embedding; and
generate the relationship constraint set including the relationship embedding set.

18. The one or more non-transitory, computer-readable storage media of claim 10, wherein the instructions further cause the computing system to:
input the simulated node dataset into a validation model to generate a validation report for the simulated node dataset,
wherein the validation report includes an indication of at least one of:
(1) a structural validation status comprising an indication of whether the simulated node dataset is consistent with the inferred entity-relationship network and the set of constraints,
(2) a statistical validation status comprising an indication of whether the simulated node dataset is consistent with the inferred statistical dataset, or
(3) a semantic validation status comprising an indication of whether the simulated node dataset is consistent with rule-based constraints associated with the set of constraints; and
input the simulated node dataset, the inferred entity-relationship network, and the validation report into the data generation model to generate an updated simulated node dataset, consistent with the inferred entity-relationship network and based on the simulated node dataset and the validation report.

19. A method comprising:
receiving a node dataset comprising a representation of a set of nodes and a set of relationships,
wherein each relationship of the set of relationships is associated with at least two particular nodes of the set of nodes;
providing the node dataset to a statistical inference model to generate an inferred statistical dataset for the node dataset,
wherein the inferred statistical dataset includes (1) a set of statistical metrics and (2) a set of statistical metric values associated with the set of statistical metrics,
wherein each statistical metric of the set of statistical metrics is associated with one or more nodes of the set of nodes or one or more relationships of the set of relationships, and
wherein the set of statistical metric values includes at least one correlation coefficient value corresponding to a correlation between a first and second node of the set of nodes;
providing at least one of the inferred statistical dataset or the node dataset to a graph generation model to generate an inferred entity-relationship network including (1) a set of inferred node identifiers corresponding to a set of inferred nodes and (2) a set of inferred node relationships,
wherein the inferred entity-relationship network includes an indication of structural, semantic, and statistical properties of the node dataset,
wherein the indication of the structural, semantic, and statistical properties is consistent with the inferred statistical dataset, and
wherein each relationship of the set of inferred node relationships indicates a particular relationship label between at least two particular nodes of the set of inferred nodes, and
wherein generating the inferred entity-relationship network comprises modifying the set of relationships based on the inferred statistical dataset, including:
adding, to the inferred entity-relationship network and based on the at least one correlation coefficient value between the first and second nodes, an inferred relationship between the first and second nodes when the inferred relationship is not included in the set of relationships, and
excluding, from the inferred entity-relationship network, a relationship of the set of relationships when an explicit correlation associated with the relationship is not statistically significant;
generating, using the inferred entity-relationship network, a set of constraints for generation of simulated data;
providing at least a portion of the set of constraints and the inferred entity-relationship network to a data generation model to generate a simulated node dataset consistent with the set of constraints and the inferred entity-relationship network including the inferred relationship,
wherein the generated simulated node dataset exhibits the at least one correlation coefficient value of the inferred statistical dataset; and
transmitting the simulated node dataset to a user device to cause validation or training, using the simulated node dataset, of an artificial intelligence model.

20. The method of claim 19, wherein generating the simulated node dataset comprises:
determining a specialized generative model set associated with the data generation model,
wherein each specialized generative model of the specialized generative model set is associated with a particular model specialization of a model specialization set;
generating, based on: (1) the inferred entity-relationship network, (2) the set of constraints, and (3) the model specialization set, a portion set,
wherein each portion of the portion set corresponds to a particular portion of the inferred entity-relationship network or a particular portion of the set of constraints, and
wherein each portion of the portion set is associated with a corresponding model specialization of the model specialization set;
providing each portion of the portion set to a corresponding specialized generative model of the specialized generative model set that is associated with a corresponding model specialization of the model specialization set to generate a model output set; and
generating the simulated node dataset including the model output set.
